(19) United States
(12) Patent Application Publication
(10) Pub. No.: US 2026/0149631 A1
(43) Pub. Date: May 28, 2026

(54) METHODS, ARCHITECTURES, APPARATUSES AND SYSTEMS FOR TRANSMISSION CONFIGURATION INDICATION MANAGEMENT IN NEAR-FIELD

(71) Applicant: InterDigital Patent Holdings, Inc., Wilmington, DE (US)

(72) Inventors: Chia-Hung Wei, Chesterbrook, PA (US); Patrick Svedman, Stockholm (SE); Afshin Haghighat, Ile-Bizard (CA); Allan Yingming Tsai, Boonton, NJ (US); Ravikumar Pragada, Warrington, PA (US); Jonghyun Park, Syosset, NY (US); Yifan Li, Conshohocken, PA (US); Benoit Pelletier, Roxboro (CA); Salah Elhoushy, LaSalle (CA)

(21) Appl. No.: 18/961,926

(22) Filed: Nov. 27, 2024

(51) Int. Cl. H04L 27/26; H04B 7/06; H04B 17/318; H04L 5/00; H04W 24/10

(52) U.S. Cl. CPC H04L 27/261; H04B 7/06968; H04B 17/328; H04L 5/0053; H04W 24/10

(57) ABSTRACT

Procedures, methods, architectures, apparatuses, systems, devices, and computer program products for transmission configuration indication, TCI, management in near-field, NF, are described. A wireless transmit-receive unit, WTRU, may be configured with multiple TCI sets. Each TCI set may consist of TCI states of NF beams and a TCI state of far-field, FF, beam. The WTRU may determine and may report a preferred TCI set based on measurement on a source reference signal of a TCI state of FF beam. The WTRU may be indicated with an active TCI set and a semi-active TCI set. The active/semi-active status may be switched via downlink control information. The switching delay from semi-active to active status is shorter than from de-active to active status.

### INCORPORATION BY REFERENCE

The following documents are incorporated by reference in their entirety: 3GPP TS 38.321 “NR; Medium Access Control (MAC) protocol specification”, Release 18, V18.3.0 (2024-09); 3GPP TS 38.212 “NR; Multiplexing and channel coding”, Release 18, V18.4.0 (2024-09); 3GPP TS 38.214 “NR; Physical layer procedures for data”, Release 18, V18.4.0 (2024-09); 3GPP TS 38.213 “NR; Physical layer procedures for control”, Release 18, V18.4.0 (2024-09); 3GPP TS 38.331 “NR; Radio Resource Control (RRC); Protocol specification”, Release 18, V18.3.0 (2024-09)

### BACKGROUND

The present disclosure is generally directed to the fields of communications, software and encoding, including, for example, to methods, architectures, apparatuses, systems related to transmission configuration indication (TCI) management in near-field (NF).

### SUMMARY

There are disclosed embodiments of methods, as described in the following and as claimed in the appended claims.

There are disclosed embodiments of a device, as described in the following and as claimed in the appended claims.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a flow-chart of TCI set management according to an embodiment;

FIG. 3 is an illustration of NF TCI states;

FIG. 4 is an illustration of FF TCI states;

FIG. 5 is an illustration of TCI sets;

FIG. 6 is a flow chart of Preferred TCI state determination and reporting according to an embodiment;

FIG. 7 is an example format of MAC CE carrying status switching indicator;

FIG. 8 is a further example format of MAC CE carrying status switching indicator;

FIG. 9 is an illustration of TCI status (TCI set status) switching;

FIG. 10 is an illustration of delay of TCI state application;

FIG. 11 is a flow chart of preferred TCI set selection;

FIG. 12 is a comparison of TCI state application delays;

FIG. 13 is an illustration of PDCCH monitoring considering D2 delay; and

FIG. 14 is a flow chart of an embodiment of a method for TCI management in NF.

### DETAILED DESCRIPTION

### Abbreviations and Acronyms

5GS 5G System
ACK Acknowledgement
BAT Beam Application Time
BWP Bandwidth Part
CORESET Control Resource Set
CRC Cyclic Redundancy Check
CSI-RS Channel State Information Reference Signal
D1/D2 Delay 1/Delay 2
DCI Downlink Control Information
DL Downlink
DMRS Demodulation Reference Signal
FF Far Field
gNB g Node B
HARQ Hybrid Automatic Repeat Request
ID Identifier
IE Information Element
IP Internet Protocol
L1 5G Physical Layer
L2 5G MAC Layer
LCID Logical Channel ID
MAC CE Medium Access Control-Control Element
NF Near Field
NR New Radio
PDCCH Physical Downlink Control Channel
PDSCH Physical Downlink Shared Channel
PUCCH Physical Uplink Control Channel
PUSCH Physical Uplink Shared Channel
RNTI Radio Network Temporary Identifier
RRC Radio Resource Control
RS Reference Signal
RSRP Reference Signal Received Power
QAM Quadrature Amplitude Modulation
QCL/QCLed Quasi-Colocated
QCL-A/B/C/D QCL type A/B/C/D
QoS Quality of Service
SINR Signal to Noise and Interference Ratio
SNR Signal to Noise Ratio
SRS Sounding Reference Signal
SSB Synchronization Signal Block
SSI Status Switching Indicator
TAI TCI state Association Indicator
TCI Transmission Configuration Indication
UE User Equipment
UL Uplink
WTRU Wireless Transmit-Receive Unit

### Terminology

Far-Field (FF) Beamforming: Multi-antenna transmission/reception scheme that focuses transmitted/received energy to/from an angular direction in the far field;
FF beam: The beam, e.g., in the FF, applying FF beamforming;
gNB: This term is used to refer to a network node. The node may for instance configure, control, and communicate with a WTRU. The node may terminate a communication protocol with the WTRU. Even though this term is used in 5G systems, the solutions herein are not limited to 5G NR.
Near-Field (NF) Beam-focusing: Multi-antenna transmission/reception scheme that focuses transmitted/received energy to/from an angular direction and focus distance in the near-field.
NF beam: The beam, e.g., in the NF, applying NF Beam-focusing; may be called “spot beam”;
TCI state: Indicating which (source) RS should be applied by WTRU for specific type of QCL property or parameter estimation for a target channel/RS reception/transmission;
TCI set: One or more of TCI states which are grouped as a logical set. The purpose of the grouping may be for TCI management;
TCI status: A logical status of a TCI state which may be indicated by gNB and/or determined by WTRU. The TCI status may be used by the WTRU for determining RS monitoring and for TCI state indicator interpretation;
TCI set status: A logical status of a TCI set which may be indicated by gNB and/or determined by WTRU. The TCI set status may be used by the WTRU for determining RS monitoring and for TCI state indicator interpretation. The TCI states in a TCI set may have a TCI status corresponding to the TCI set status of the TCI set;
NF TCI state: An NF TCI state is a first type of TCI state. For example, an NF TCI state may be a TCI state with a source RS that is associated with/transmitted by a NF beam;
FF TCI state: A FF TCI state is a second type of TCI state. For example, a FF TCI state may be a TCI state with a source RS that is associated/transmitted with a FF beam;
Source RS: A (set of) RS associated with a TCI state, wherein the RS may for example be a CSI-RS, SSB, SRS, DMRS, etc. The (set of) RS is assumed to be QCLed with one or more target RS. Wherein the one or more target RS may be associated with a target channel, e.g., PDCCH, PDSCH, PUCCH, PUSCH, etc. Wherein the target channel is a channel that, or the associated target RS, has been indicated to be received/transmitted based on the TCI state;
Active TCI state list: A set of TCI states that have been indicated to the WTRU as activated;
Active TCI state list update delay: A time interval between the WTRU receives a command to activate one or more TCI states from the configured TCI states, and the WTRU is ready to receive a TCI state indicator (e.g., via DCI) that indicates to the WTRU to apply the one or more of TCI states to a target RS/channel. Wherein applying a TCI state in the present disclosure may be interpreted as assuming the source RS of the TCI state is QCLed with a target RS/channel;
TCI state application delay: A time interval between the WTRU receives a command to apply an activated TCI and the WTRU ready to apply the indicated TCI state. It is also called Beam Application Time (BAT) application time of the beam indication or can be called as TCI state switching delay;
Active status: A first TCI status of a TCI state. A TCI state in active status may be indicated to apply for downlink RS/channel reception and/or uplink RS/channel transmission. After a WTRU receiving a TCI state indicator indicating an active TCI state, the WTRU should be able to apply the active TCI state within an TCI state application delay. The status may also be called activated status.
De-active status: A second TCI status. A TCI state in de-active status typically cannot applied for RS/channel reception and/or uplink RS/channel transmission. That is, WTRU does not expect the de-active TCI state be indicated to apply for any downlink RS/channel reception and/or uplink RS/channel transmission. The status may also be called deactivated status or inactive status.
Semi-active status: A third TCI status of a TCI state. A TCI status switching delay for a TCI state from semi-active to active status may be shorter than from de-active to active. WTRU is assumed to perform less intense of source RS monitoring/tracking for a TCI state (or TCI set) in semi-active status than in active status. The status may also be called semi-activated status.
Status Switching Indicator (SSI): An indicator for indicating a TCI status/TCI set status switching.

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

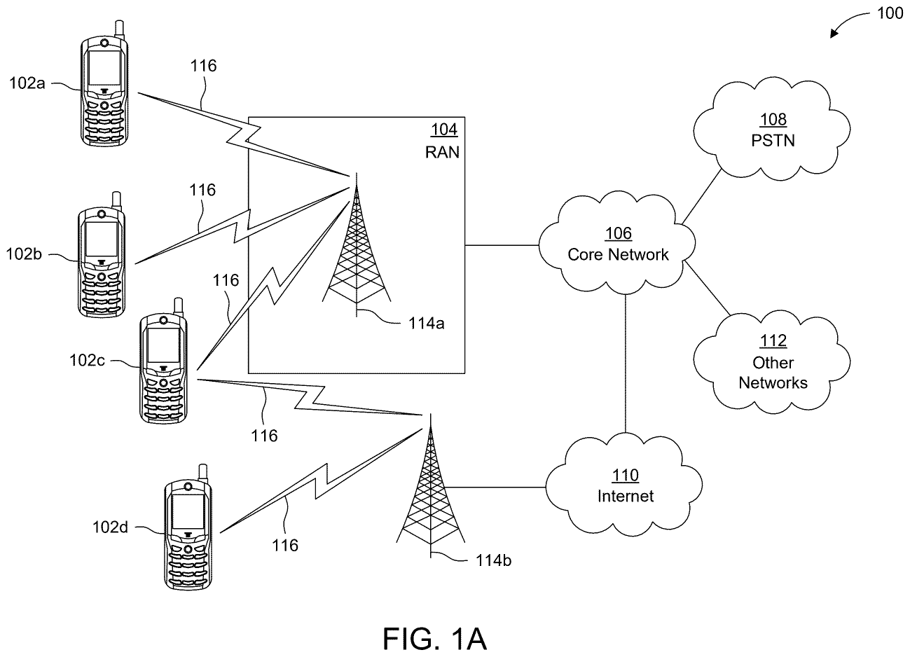

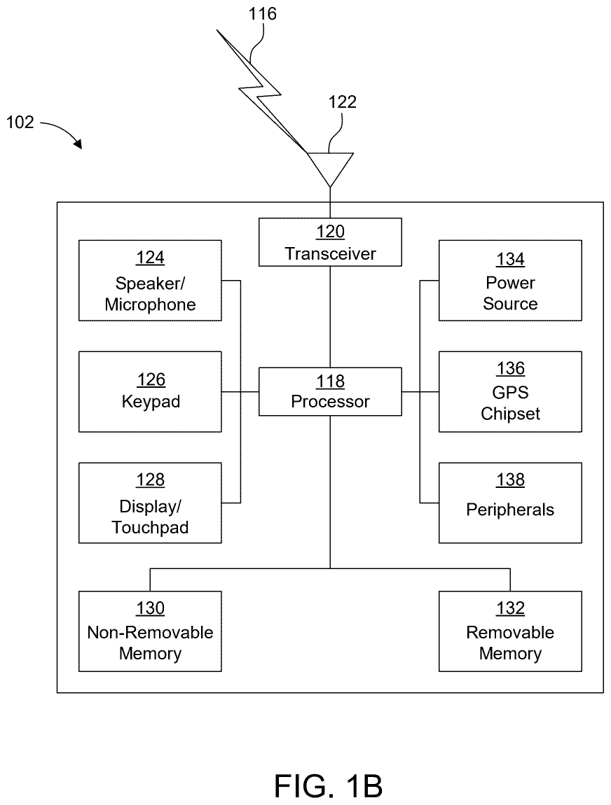

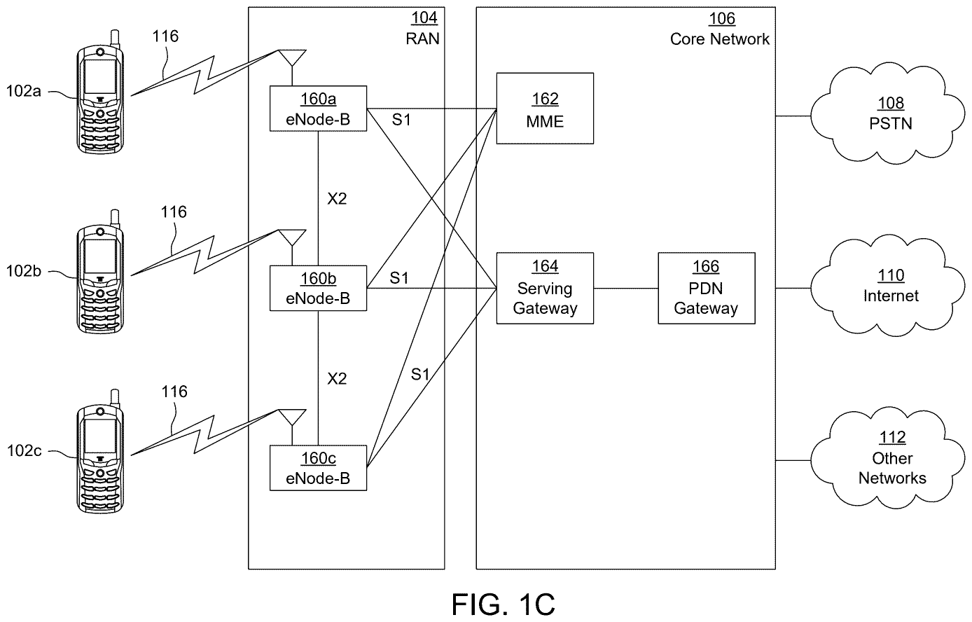

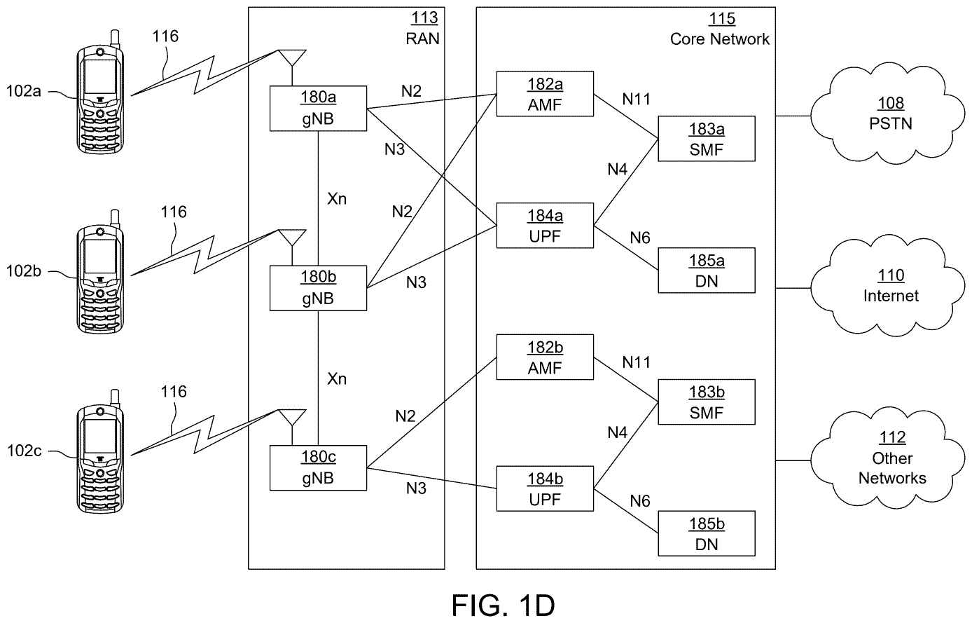

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114 b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114 b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Introduction

pIn legacy New Radio (NR) wireless communication systems, a transmission configuration indication (TCI) framework is employed for beam management. A WTRU can be indicated with a TCI state to be applied for a downlink channel reception and/or an uplink channel transmission. Each TCI state may indicate one or two source RS to be applied for different type of QCL properties (e.g., parameter) estimation. For example, in 5G NR there are four types of QCL properties: QCL-TypeA for Doppler shift, Doppler spread, average delay and delay spread; QCL-TypeB for Doppler shift, Doppler spread; QCL-TypeC for Doppler shift, average delay; and QCL-TypeD for Spatial Rx parameter.

Before TCI states are configured by the network node, the WTRU may need to report, to the network node, TCI state related capabilities such as activation and switching delay, maximum number of TCI states that can be configured and the maximum number of TCI states that can be activated. The WTRU may be pre-configured, by the network node via RRC, with multiple TCI states as candidates. A subset of the pre-configured TCI states may be activated by the network node via MAC CE. The TCI states which have been activated by the MAC CE may be indicated, by the network node via DCI, to be applied by the WTRU for downlink channel reception and/or uplink channel transmission. WTRU may apply the indicated TCI state, e.g., use the corresponding estimated QCL properties, to perform the corresponding downlink channel reception and/or uplink channel transmission.

Far-Field (FF) beamforming is a multi-antenna transmission/reception scheme that focuses transmitted/received energy to/from an angular direction in the far field. The beam in the FF is also named ‘FF beam’. Near-Field (NF) beam-focusing is a multi-antenna transmission/reception scheme that focuses transmitted/received energy to/from an angular direction and a focus distance in the near-field. The beam in the NF is also named ‘NF beam’ or ‘spot beam’.

SNR in NF is expected to be significantly high. To have high spectral efficiency, a PDSCH transmitted by a NF beam may adopt a higher-order modulation scheme (e.g., 1024 QAM). However, the reception of a PDSCH with high-order modulation needs to be based on accurate QCL estimation.

Since the transmission channel and multi-path reflection for NF and FF may be different, the QCL type A and B properties estimated based on a source RS transmitted by a FF beam may not accurate enough for receiving a PDSCH transmitted by a NF beam. Hence, a TCI state indicating QCL Type A and B information associated with a FF beam cannot be shared with a NF beam even if the FF beam and NF beam have the same spatial direction.

Since the coverage area of a NF beam may be relatively smaller than the coverage area of a FF beam, a WTRU may cross the coverage area of different NF beams more frequently than in FF.

In NF, to indicate to the WTRU different beams (via different TCI states) that focus on different directions and distances in NF, the number of TCI states needed for NF may be much higher than the number of TCI states needed for FF.

To have more candidate TCI states to be applied for indication, the network node either needs to increase the number of active TCI states or to frequently update an active TCI state list via MAC CE and/or switch TCI state via DCI.

The delay for active TCI state list update via MAC CE is in the order of multiple milliseconds. The delay for applying a TCI state indicated via DCI is in the order of multiple symbols. To ensure that a TCI state in active list can be applied with symbol level delay, the WTRU needs to spend its effort on tracking source RS of the active TCI state.

The maximum number of TCI states that can be activated is limited by the WTRU's capability. In NF, to reduce delay from frequent TCI state (de)activation due to the coverage of spot beams being relatively small, the WTRU may need to have more active TCI states. However, having more active TCI states may increase WTRU's burden on tracking source RS and/or may increase signaling overhead on TCI state (de)activation and TCI state indication.

### Overview

According to an embodiment of a method for TCI management in NF, which is further described in more detail in the next sections, a WTRU may be configured with multiple TCI sets via RRC. Each TCI set may comprise multiple TCI states of NF beams and a TCI state of an FF beam. The WTRU may determine and may report a TCI set (e.g., a ‘preferred’ TCI set) based on measurement on a source RS of a TCI state of FF beam. The WTRU is indicated with an active TCI set and a semi-active TCI set via a MAC CE. The active/semi-active status may be switched via a DCI. The switching delay from semi-active state to active state is shorter than from de-active (inactive) to active state.

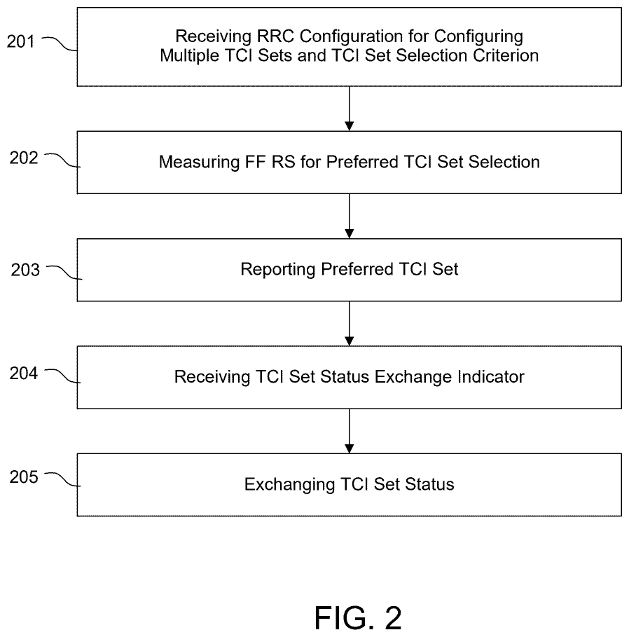

See FIG. 2.

In 201, a WTRU may receive a RRC message from a network node, the RRC message may comprise: a TCI set configuration, indication of multiple TCI sets each consisting of multiple TCI states associated with NF beam (NF TCI states) and a TCI state associated with FF beam (FF TCI state); and a TCI set selection configuration, indicating a TCI set selection criterion (e.g., RSRP threshold).

In 202, the WTRU may measure and may determine at least a preferred TCI set based on measurement on source RS of FF TCI state of each TCI set and the TCI set selection criterion; E.g., the WTRU may select a TCI set which may comprise a FF TCI state which source RS having RSRP higher than indicated in the TCI set selection criterion.

In 203, the WTRU may report, to the network node, the preferred TCI set. The network node may, or may not, take the reporting into account. The network may confirm receipt of the report.

Then, the WTRU may receive, from the network node, a MAC CE indicating a first TCI set in active status and a second TCI set in semi-active status; E.g., a first TCI set with QCL type D source RS tracking, and second TCI set with QCL type A RS tracking. The first TCI set (to set in active status) may, or may not, e.g., according to a network node decision, correspond to the preferred TCI set reported by the WTRU;

Then, the WTRU may receive a first DCI including a TCI indicator indicating a first value;

Then, the WTRU may transmit UL feedback (e.g., HARQ feedback) in response to the reception of the first DCI reception;

Then, the WTRU may receive a second DCI scheduling a first PDSCH reception;

Then, the WTRU may determine a TCI state to be applied for the first PDSCH reception based on the first value and the first TCI set;

In 204, the WTRU may receive, from the network node, a third DCI indicating to switch the first TCI set into semi-active status and indicating to switch the second TCI set into active status; E.g., a TCI field of the third DCI be set to a particular value indicating the status of the first and the second two TCI set should be exchanged; and

In 205, the WTRU may exchange the TCI set status of the first TCI set with the TCI set status of the second TCI set accordingly.

Among the benefits of the above method are:

By grouping multiple TCI states into TCI sets, the signaling related to TCI management may be reduced;

By associating each TCI set with a specific source RS (i.e., a QCL type D source RS of FF TCI state), the WTRU may efficiently select which TCI set is preferred to be applied, based on limited number of source RS measurements;

By introducing the semi-active status, the amount of TCI states that can be applied in a limited delay may be increased based on the WTRU spending a lesser amount of effort on RS tracking. That is, the WTRU may only need to monitor source RS for QCL type D without monitoring source RS for QCL type A/B/C of the TCI state with semi-active status; and

(TCI state) Status Switching Indicator overhead is saved (reduced).

### WTRU Capability Reporting

### [WTRU Reports Whether it Supports Semi-Active Status for a TCI State]

According to an embodiment, a WTRU may report to the network node whether it supports semi-active status. That is, a WTRU may report to the network node whether it supports a TCI state to be in semi-active status (or to be switched to semi-active status). In one embodiment, the WTRU may report to the network node whether it supports the operation of a TCI state in semi-active status. It is noted that the corresponding reporting may, but not limited to, be carried by a UECapabilityInformation message as defined in 3GPP TS 38.331, or similar.

It is noted that the semi-active status mentioned in the present disclosure may be interpreted as a new RS monitoring behavior/pattern and/or a new RS monitoring behavior to meet a D2 timeline (or D2 requirement) defined and illustrated in the sections “Confirmation of the status indication”, “State-based TCI set and TCI state application delay determination” and so on. Specifically, a TCI state in semi-active status mentioned in the present disclosure may be interpreted as the WTRU may, but is not limited to, monitor the TCI state corresponding source RS (as defined in section “Hierarchical Source RS Tracking management”) to meet the D2 requirement when the TCI state is indicated to switch to active status. More specifically, the WTRU may apply a first RS monitoring behavior for a TCI state to meet a D1 timeline (or requirement) defined and illustrated in the sections “Confirmation of the status indication”, “State-based TCI set and TCI state application delay determination”, if the TCI state is in active status. The WTRU may apply a second RS monitoring behavior for the TCI state to meet the D2 timeline, if indicated by the SSI introduced later in section “TCI status (TCI set status) indication”.

In one embodiment, the WTRU may per Bandwidth Part (BWP), Serving cell, Carrier, Frequency band and/or Serving Cell Group, report whether it supports the semi-active status. For example, in case of a WTRU per serving cell reports whether it supports the semi-active status, the WTRU may indicate to the network node for which of configured serving cell(s) the WTRU supports the semi-active status.

It is noted that the semi-active status is a new TCI status introduced here to support corresponding WTRU behavior, e.g., to meet a specific delay requirement. Specifically, the WTRU should be able to switch a TCI state from semi-active status to active status within a specific switching delay. That is, once the WTRU is indicated to switch the TCI state from semi-active to active status, the WTRU should guarantee that the TCI state may be applied for certain channel transmission/reception after the specific switching delay. In one interpretation, a TCI state switched to active status may be interpreted as the TCI state is ready to be applied for corresponding RS/channel transmission/reception. More specifically, the WTRU behavior may include the WTRU monitoring of a (source) RS associated with the TCI state for specific type of QCL property estimation. It is noted that the TCI switching from semi-active status to active status may be indicated/triggered by a Status Switching Indicator (SSI) received from the network node, wherein the SSI indicator may be implemented as either:
SSI is carried in one or more field(s) of a specific type (format) of a DCI;
SSI is carried in one or more field(s) of a specific type (format) of a MAC CE; or
SSI is one or more Information Element(s) (IEs) in specific RRC message.

The switching delay, for a TCI state, from a semi-active status to an active status may be defined as one or more of alternatives as following:
A time interval between receiving the SSI and the TCI state be switched to active status;
A time interval between receiving a DCI carrying the SSI and the TCI state be switched to active status;
A time interval between receiving a PDCCH carrying a DCI carrying the SSI and the TCI state be switched to active status;
A time interval between receiving a DCI and the TCI state be switched to active status, wherein the DCI scheduling a PDSCH reception and the PDSCH carrying a MAC CE carrying the SSI;
A time interval between receiving a PDSCH and the TCI state be switched to active status, wherein the PDSCH carrying a MAC CE carrying the SSI;
A time interval between receiving a DCI and the TCI state be switched to active status, wherein the DCI scheduling a PDSCH reception and the PDSCH carrying an IE carrying the SSI;
A time interval between receiving a PDSCH and the TCI state be switched to active status, wherein the PDSCH carrying an IE carrying the SSI.

### [WTRU Reports a Maximum Number of TCI States it Supports to be Configured as Semi-Active Status]

A WTRU may report its semi-active status related capability to the network node. For example, the WTRU may report, to the network node, a maximum number of TCI states the WTRU supports to be operated (indicated as) in semi-active status. In one embodiment, the WTRU may report to the network node a maximum number of TCI states that can be configured and/or indicated as in semi-active status.

In one embodiment, the WTRU may per Bandwidth Part (BWP), WTRU, serving cell, carrier, frequency band and/or serving cell group report its semi-active status related capability.

It is noted that, in the present disclosure, “a TCI state is indicated with a TCI status (e.g., de-active, semi-active or active)” may be interchangeable with “a TCI state with a TCI status”, “a TCI state is operated in a TCI status”, and “a TCI state is indicated to switch to a TCI status”.

A WTRU may report, to the network node, a joint capability for both of semi-active status and active status. That is, the joint capability indicates WTRU's capability of supporting semi-active status related and active status related capability. For example, the joint capability may indicate the WTRU's capability corresponding to a maximum number of TCI states in semi-active status and a maximum number of TCI states in active status, MAX_{TCI}:
In one embodiment, the WTRU may report a MAX_{TCI} to the network node, and the MAX_{TCI} is defined as a sum of a maximum number of TCI states with semi-active status plus a maximum number of TCI states with active status;
In another embodiment, the WTRU may report a MAX_{TCI} to the network node, and the MAX_{TCI} is defined as a function of a number of TCI states with semi-active status plus a number of TCI state with active status;
In further embodiments, the WTRU may report a MAX_{TCI} to the network node, and the MAX_{TCI} is defined as a function of a maximum number of TCI states with semi-active status plus a maximum number of TCI states with active status.

A WTRU may report, to the network node, a ratio capability for semi-active and active status. For example, the ratio capability may indicate WTRU's capability corresponding to a ratio between a number of TCI states with semi-active status and a number of TCI states with active status, Ratio_{TCI}:
In one embodiment, the WTRU may report a Ratio_{TCI} to the network node, and the Ratio_{TCI} is defined as a ratio between a maximum number of TCI states with semi-active status and a maximum number of TCI states with active status; For example, if the Ratio_{TCI} equal to two is indicated to the network node, it implies that the WTRU supports the number of TCI states with semi-active status up to double to the number of TCI state with active status;
In another embodiment, the WTRU may report a maximum number of TCI states with active status and a Ratio_{TCI} to the network node; For example, the WTRU may report a maximum number of TCI states with active status equal to X and Ratio_{TCI} equal to 2 to the network node. It implies that the WTRU supports the number of TCI states with semi-active status is 2X;
In another embodiment, the WTRU may report a maximum number of TCI states with semi-active status and a Ratio_{TCI} to the network node. For example, the WTRU may report a maximum number of TCI states with semi-active status equal to X and Ratio_{TCI} equal to 2 to the network node. It implies the WTRU supports the number of TCI states with semi-active status is X/2;
In some other embodiments, the WTRU may report a maximum number of TCI states (MAX_{TCI}) and a first coefficient parameter for TCI state with semi-active status and a second coefficient parameter for TCI state with active status. In addition, the sum of the number of TCI states with semi-active status multiplied by the first coefficient parameter plus the number of TCI states with active status multiplied by the second coefficient parameter should be equal to or less than the MAX_{TCI}.
   [WTRU Reports Capabilities Related to TCI Status Switching Delay and/or TCI Set Status Switching]

It is noted that the WTRU may report its capability related to the TCI status switching (e.g., from semi-active status to active status, or from de-active to semi-active status). That is, the WTRU may report a minimal time the WTRU requires for switching a TCI state from semi-active status to active status. Or, the WTRU may report a minimal time the WTRU requires for switching a TCI state from de-active status to semi-active status. Or, it may be interpreted as the minimal time the WTRU needs to guarantee the TCI state may be applied for certain channel transmission/reception in the switching delay after receiving a SSI indicating the TCI status switching.

As introduced earlier on in the present disclosure, TCI status switching from a first TCI status to a second TCI status may be indicated via a SSI. That is, the SSI may be applied by the network node to indicate WTRU to switch a TCI status of a TCI state.

It is noted that, in the present disclosure, a TCI set may comprise one or multiple TCI states. In case of a TCI set only comprising one TCI state, the switching of the TCI status (i.e., the TCI status of the one TCI state within the TCI set) may equal to the switching of the TCI set status. In addition, the “TCI status switching delay” introduced later may equal to “TCI set status switching delay” in case of the TCI set only consist of one TCI state. That is the embodiments listed as below for TCI status switching delay may be extended to TCI set status switching.

The TCI status switching delay, for a TCI state, from a first TCI status to a second TCI status may be defined according to one or more of the following alternatives:
A time interval between receiving the SSI and the TCI state be switched to the second status;
A time interval between receiving a DCI with CRC bits scrambled by a specific RNTI and the TCI state be switched to the second TCI status;
A time interval between receiving a DCI carrying the SSI and the TCI state be switched to the second TCI status;
A time interval between receiving a PDCCH carrying a DCI carrying the SSI and the TCI state be switched to the second TCI status;
A time interval between receiving a DCI and the TCI state be switched to the second TCI status, wherein the DCI scheduling a PDSCH reception and the PDSCH carrying a MAC CE carrying the SSI;
A time interval between receiving a PDSCH and the TCI state be switched to the second TCI status, wherein the PDSCH carrying a MAC CE carrying the SSI; Specifically, in one embodiment, the time interval may be starting from a last slot WTRU receiving the PDSCH and a second slot the TCI state be switched to the second TCI status; Specifically, in one embodiment, the time interval may be starting from a last symbol the WTRU receiving the PDSCH and a symbol the TCI state be switched to the second TCI status;
A time interval between receiving a DCI and the TCI state be switched to the second TCI status, wherein the DCI scheduling a PDSCH reception and the PDSCH carrying an IE carrying the SSI; Specifically, in one embodiment, the time interval may be starting from a first slot WTRU receiving a DCI and a second slot the TCI state be switched to the second TCI status; Specifically, in one embodiment, the time interval may be starting from a last symbol the WTRU receiving a DCI and a symbol the TCI state be switched to the second TCI status;
A time interval between receiving a PDSCH and the TCI state be switched to the second TCI status, wherein the PDSCH carrying an IE carrying the SSI;
A time interval between WTRU transmitting a HARQ feedback in response to receiving a DCI carrying the SSI (indicating to switch to second status) and the TCI state be switched to the second status; Specifically, in one embodiment, the time interval may be starting from a first slot WTRU transmitting the HARQ feedback and a second slot the TCI state be switched to the second TCI status; Specifically, in one embodiment, the time interval may be starting from a last symbol the WTRU transmitting the HARQ feedback and a symbol the TCI state be switched to the second TCI status.

It is noted that, in one embodiment, all TCI state in a TCI set may be in a same TCI status. That is, all TCI states in a TCI set may be in one of de-active status, semi-active status or active status. For example, if a TCI set has eight TCI states, and the TCI set is in semi-active status. Then, it implies that the eight TCI states are all in the semi-active status.

In one embodiment, the SSI may be used by the network node to indicate a switching of a TCI set status. That is, a network node may transmit a SSI to a WTRU to indicate to the WTRU to switch a TCI set status of a TCI set from a first TCI set status to a second set TCI status.

The WTRU may report its capability related to the TCI set status switching (e.g., from semi-active status to active status, or from de-active to semi-active status). That is, the WTRU may report a minimal time the WTRU requires for switching a TCI set from semi-active status to active status. Or, the WTRU may report a minimal time the WTRU requires for switching a TCI set from de-active status to semi-active status.

A TCI set status may be indicated to switch from a first TCI set status to a second set TCI status via an SSI. That is, the SSI may be applied by the network node to indicate to the WTRU to switch a TCI set status of a TCI set.

The TCI set status switching delay, for a TCI set, from a first TCI set status to a second TCI set status may be defined in one or more alternative embodiments as introduced above for TCI status switching delay. That is, all alternative definitions of time interval for TCI status switching delay from first TCI status to second TCI status may be logically adopted for TCI set status switching delay from first TCI set status to second TCI set status.

### [WTRU Reports Whether it Supports TCI Set, and a Maximum Number of TCI Sets]

A WTRU may report its TCI set related capability to the network node. For example, the WTRU may report to the network node whether it supports the operation for TCI set. In another example, the WTRU may report to the network node whether it can be configured with one or more TCI sets.

A WTRU may report to the network node a maximum number of TCI sets that can be configured by a network node to the WTRU.

### [WTRU Reports a Maximum Number of TCI Sets it Supports to be Configured as Semi-Active Status]

A WTRU may report to the network node a maximum number of TCI sets the WTRU supports to be operated (indicated) in semi-active status. In one embodiment, the WTRU may report to the network node a maximum number of TCI sets can be configured and/or indicated as semi-active status.

A WTRU may report, to the network node, a joint capability for semi-active and active status. For example, the joint capability may indicate WTRU's capability corresponds to a maximum number of TCI set be indicated as semi-active status and a maximum number of TCI set be indicated as active status, MAX_{TCI_SET}:
In one embodiment, the WTRU may report a MAX_{TCI_SET} to the network node, and the MAX_{TCI_SET} is defined as a sum of a maximum number of TCI set with semi-active status plus a maximum number of TCI set with active status;
In another embodiment, the WTRU may report a MAX_{TCI_SET} to the network node, and the MAX_{TCI_SET} is defined as a function of a number of TCI set with semi-active status plus a number of TCI set with active status;
In further embodiments, the WTRU may report a MAX_{TCI_SET} to the network node, and the MAX_{TCI_SET} is defined as a function of a maximum number of TCI set with semi-active status plus a maximum number of TCI set with active status.

A WTRU may report its capability corresponds to a ratio between a number of TCI set with semi-active status and a number of TCI set with active status, Ratio_{TCI_SET}:
In one embodiment, the WTRU may report a Ratio_{TCI_SET} to the network node, and the Ratio_{TCI_SET} is defined as a ratio between a maximum number of TCI set with semi-active status and a maximum number of TCI set with active status;
In another embodiment, the WTRU may report a maximum number of TCI set with active status and a Ratio_{TCI_SET} to the network node;
In another embodiment, the WTRU may report a maximum number of TCI set with semi-active status and a Ratio_{TCI_SET} to the network node.

It is noted that, the WTRU may, per WTRU, per BWP, serving cell, carrier, frequency band and/or serving cell group reports its:
semi-active status related capability;
maximum number of TCI set related capability;
TCI status switching delay; and/or
TCI set status switching delay.

For example, in case of the WTRU per service cell report the capability, the WTRU may indicate to the network node a maximum number of TCI states with semi-active status for a serving cell. It is noted that, the semi-active status corresponding capability reporting may be but not limited to be carried by a UECapabilityInformation message as defined in 3GPP TS 38.331.

### Configuration of Beam type Dependent TCI State (Without TCI Set)

### Beam Type Dependent TCI States

[Configuring TCI State with Source RS Transmitted by NF Beam (NF TCI State)]

A WTRU may be configured by a network node, via RRC message, with one or more of NF TCI states, e.g., for each configured BWP, serving cell, carrier, frequency band and/or serving cell group. Wherein a NF TCI state may be defined as a TCI state with a source RS associated with (or transmitted by) a NF beam. In other words, a WTRU may determine that a TCI state is a NF TCI state based on the NF TCI state corresponding configuration.

In one embodiment, the network node may explicitly or implicitly indicate to the WTRU that a source RS associated with a TCI state is associated with a NF beam. In one example, the WTRU may determine that a TCI state is a NF TCI state based on that a source RS associated with the TCI state is associated with a NF beam. In another example, the WTRU may determine that a TCI state is a NF TCI state based on an explicit TCI state type indicator, wherein the TCI state type indicator indicating whether the TCI state is a NF TCI state.

In one embodiment, a WTRU may determine that a TCI state is a NF TCI state if there is at least a source RS associated with the TCI state that is associated with a NF beam.

In another embodiment, a WTRU may determine that a TCI state is a NF TCI state if there is at least a source RS that is configured for a specific type of QCL property (e.g., of type A, B or C as defined in 3GPP TS 38.214).

In some other embodiments, a WTRU may determine that a TCI state is either a NF TCI state or a FF TCI state based on the type of QCL property of source RS configured for the TCI state. For example, if the TCI state is configured with source RS, and the source RS is only for a first specific type of QCL property (e.g., of type A, B or C), the WTRU determines the TCI state is a NF TCI state. If the TCI state is configured with source RS, and the source is only for a second specific type of QCL property (e.g., of type D), the WTRU determines the TCI state is a FF TCI state.

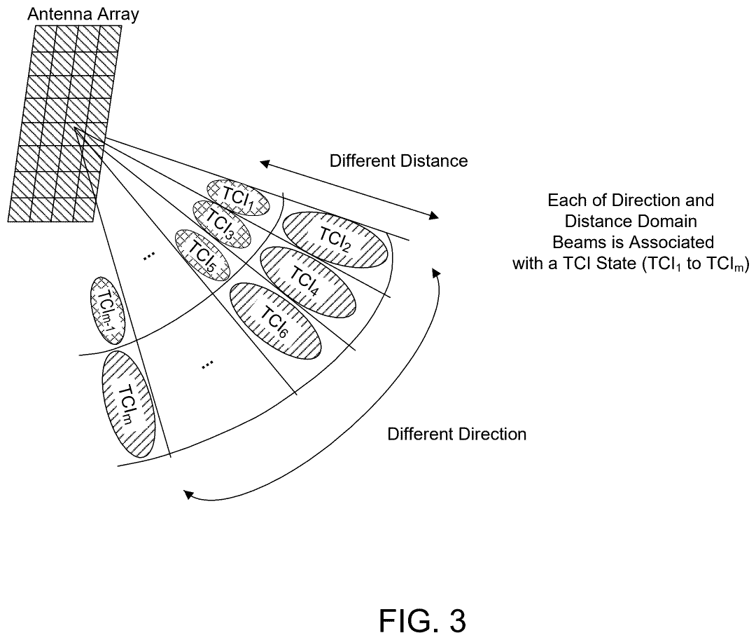

As shown in FIG. 3, a WTRU may be configured by a network node, via RRC message, with one or more NF TCI states (m in FIG. 3, i.e., TCI₁ to TCIₘ). Each NF TCI state is associated with (one or more source RS transmitted by) a NF beam focusing on a specific direction and a specific distance.

It is noted that, in the present disclosure, a TCI state with a source RS may be interpreted as that the TCI state is associated with a source RS configuration, and the source RS configuration indicating a RS transmitted by a network node to be received by the WTRU.

It is also noted that, in the present disclosure, a TCI state with a source RS associated with a specific type of beam (e.g., NF beam or FF beam) may be interpreted as the TCI state with the source RS, and the source RS is transmitted (by a network node) via the specific type of beam.

[Configuring TCI State with Source RS Transmitted by FF Beam (FF TCI State)]

A WTRU may be configured by a network node, via RRC message, with one or more of FF TCI state for each configured BWP, serving cell, carrier, frequency band and/or serving cell group.

A FF TCI state may be defined as a TCI state with a source RS associated (transmitted) by a FF beam. In other words, a WTRU may determine a TCI state is a FF TCI state based on the FF TCI state corresponding configuration.

In one embodiment, the network node may explicitly or implicitly indicate to the WTRU that a source RS associated with a TCI state is associated with a FF beam. In one example, the WTRU may determine that a TCI state is a FF TCI state based on that a source RS associated with the TCI state is associated with a FF beam.

In another embodiment, the WTRU may determine that a TCI state is a FF TCI state based on an explicit TCI state type indicator, wherein the TCI state type indicator indicating whether the TCI state is a FF TCI state.

In one embodiment, a WTRU may determine that a TCI state is a FF TCI state if there is at least a source RS associated with the TCI state that is associated with a FF beam.

In another embodiment, a WTRU may determine that a TCI state is a FF TCI state if there is at least a source RS that is configured for specific type of QCL property (e.g., of type D as defined in 3GPP TS 38.214).

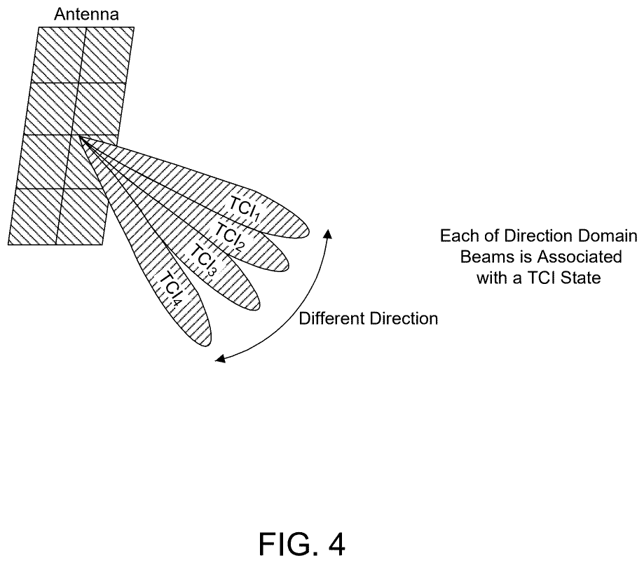

As shown in FIG. 4, a WTRU may be configured by a network node, via RRC message, with one or more FF TCI states. Each FF TCI state is associated with one or more source RS transmitted by a FF beam focusing on a specific (spatial) direction.

### Association Between NF TCI State and FF TCI State Type Dependent TCI State

[Association Between NF TCI State and FF TCI State. The Association may be Either One-to-One Mapping, One-to-Many Mapping, Many-to-One and Many-to-Many]

A WTRU may be configured by a network node, via RRC message, with an association between one or more NF TCI states and one or more FF TCI states. Wherein the association may be indicated via a TCI states Association Indicator (TAI) received from the network node. That is, a WTRU may be configured with a TAI by a network node, and the TAI indicates the WTRU which of configured NF TCI state and FF TCI state are associated with each other.

The TAI may be implemented in one or more alternative ways listed as below:
A) Explicit approaches:
A1) In one embodiment, there is a TAI carried in an IE which is applied by the network node for configuring a first TCI state configuration. Wherein the IE may be but not limited to be the TCI-State IE as defined in 3GPP TS 38.331, or similar. The TAI indicates at least a second TCI state which the first TCI state is associated with;
A2) In another embodiment, there is a TAI carried in an IE which is applied by the network node for configuring a first TCI state configuration. The TAI indicates at least a TCI state Identity (e.g., TCI-StateId) of a second TCI state. Then, the WTRU determines the first TCI state is associated with the second TCI state based on the TCI state ID carried by (associated with) the IE and the TCI state ID of the second TCI state;
A3) According to further embodiments, the TAI indicates an association within a logical group. Wherein the logical group may contain multiple TCI states. That is, all the multiple TCI states in the logical group are associated with each other. A logical group may be configured by a list of TCI state identities. The WTRU may be configured with one or more logical groups;
B) Implicit approaches:
B1) In one embodiment, the TAI is implicitly interpreted by a TCI set indicator. That is, there is a TCI set indicator carried in an IE that is applied by the network node for configuring a first TCI state configuration. The TCI set indicator indicates at least a TCI set that the first TCI state belongs to. All TCI states which have been indicated with the same value of TCI set indicator may be determined by WTRU as associated with each other.
B2) In another embodiment, the TAI is implicitly interpreted by source RS configuration(s). For example, two TCI states are determined, by the WTRU, as associated with each other if: Both TCI states have an associated source RS configuration, and the two source RS configurations are both indicating a same RS (ID); and/or Both TCI states have an associated QCL type configuration, and the two QCL type configurations are both indicating a same QCL type;

Wherein the source RS configuration is defined as a configuration applied by the network node to configure WTRU with source RS for a TCI state.

Wherein the QCL type configuration is defined as a configuration applied by the network node to configure WTRU with a type of QCL for a source RS.
B3) In further embodiments, a first TCI state is configured with a TAI, the TAI indicates the first TCI state is associated with a second TCI state. The WTRU may further determine the first TCI state is either a FF TCI state or a NF TCI state. That is, WTRU implicitly determine a TCI state with the TAI is either a FF TCI state or a NF TCI state.

### [Identification of RSs Transmitted by Different Types of Beams for Preferred TCI State Reporting]

As disclosed earlier in the present disclosure, the WTRU may determine that multiple configured TCI states are associated with each other based on either TAI or some other configurations. Among the multiple associated TCI states, the WTRU may further determine which one or more of the associated TCI state(s) that is applied for a preferred TCI state evaluation and determination (which is introduced later on in the present document).

For example, the WTRU may have determined that a first TCI state and a second TCI state are associated with each other. The WTRU may further determine which of the first and the second TCI states that is applied for a preferred TCI state evaluation.

It is noted that the preferred TCI state evaluation and determination may, but not limited to, include that the WTRU determines whether a TCI state is preferred by the WTRU or not (e.g., for PDCCH monitoring/for PDSCH reception) (will be further defined in following paragraph).

For example, the WTRU is configured with a first, a second, a third and a fourth TCI states. The first and the second TCI states are associated with each other. The third and the fourth TCI states are associated with each other. The WTRU determines that one of the first and the second TCI state is applied/selected for preferred TCI state evaluation. The WTRU determines that one of the third and the fourth TCI state is applied/selected for preferred TCI state evaluation. Based on the two determined TCI states, WTRU further evaluates/determines whether {first and second TCI states} or {third and fourth TCI states} is preferred. In other words, the WTRU may select a preferred TCI state from a set of multiple, e.g., four, TCI states, wherein set of TCI states comprises disjoint subsets, and wherein the TCI states in a disjoint subset may be associated.

In one embodiment, a TCI state with a TCI state ID having a specific value may be determined as the TCI state to be applied for preferred TCI state evaluation. The specific value may be but not limited to be a maximum value among all TCI state IDs of associated TCI states. The specific value may, but is not limited to, be a smallest value among all TCI state IDs of associated TCI states.

In another embodiment, a TCI state with a RS configuration indicating a RS ID having a specific value may be determined as the TCI state to be applied for preferred TCI state evaluation. The specific value may be but not limited to be a maximum value among all RS IDs of associated TCI states. The specific value may be but not limited to be a smallest value among all RS IDs of associated TCI states.

According to further embodiments, a TCI state with a RS configuration associated with a specific QCL type may be determined as the TCI state to be applied for preferred TCI state evaluation. The specific QCL type may be but not limited to be associated with any or a combination of spatial domain, frequency (e.g., Doppler) domain, frequency shift domain, frequency spread domain, time domain, delay domain, delay spread domain and etc. characteristics.

### Initial Status of TCI State

[Before TCI Status Switching via an L2 or L1 Command, each TCI State is Indicated as in Either One of Active, Semi-Active or De-Active Status]

A WTRU may be configured by a network node, via a RRC message, one or more TCI states. Each configured TCI states may be further indicated with an initial TCI status. That is, in response to receiving the RRC message, the WTRU may determine the one or more TCI states are in corresponding indicated TCI status respectively.

It is noted that the configured initial TCI status may be switched to other TCI status by the network node via SSI or some other indicators (e.g., DCI/MAC CE/RRC configuration).

It is noted that the first TCI state and the second TCI state mentioned above may be a NF TCI state and a FF TCI state respectively.

It is also noted that the TCI state mentioned above may be either a NF TCI state or a FF TCI state.

### Configuration of Multi-RS TCI State

### Representative Source RS for TCI State Selection

### [One of Configured Multiple Source RSs is Indicated to be Applied for TCI State Selection]

A WTRU may be configured, by a network node via a RRC message, with multiple source RSs for a TCI state. Among the multiple configured source RSs for a TCI state, the network node may further indicate to the WTRU one or more source RS(s) to be applied for TCI state selection related procedure(s). Wherein, in the present disclosure, the indicated one or more source RS(s) may be named representative source RS. Wherein the representative source RS may be used by the WTRU for some other procedures. Since there may be more than one source RS configured for a TCI state, to save WTRU's overhead on measuring all source RSs configured for the TCI state, WTRU may only need to measure the representative source RS.

The representative source RS corresponding indication may be either explicitly or implicitly implemented as one or more of embodiment(s) listed as below.

### Explicit Approach

In one embodiment, the representative source RS is indicated by a representative source RS indicator. Wherein the representative source RS indicator may, but not limited to, be:
received from the network node;
a RRC configuration;
carried by a IE;
carried by a downlink (DL) MAC CE; and/or
carried by a DCI;

In another embodiment, a WTRU is configured with a TCI state which is associated with multiple source RSs. One of the multiple source RSs is indicated as the representative source RS.

In further embodiments, WTRU may receive a representative source RS indicator for a TCI state. The representative source RS indicator indicates at least a source RS of a TCI state is the representative source RS. For example, a WTRU is configured with a TCI state which is associated with a first source RS and a second source RS. The WTRU receives a representative source RS indicator from the network node. The representative indicates at least one of the first and the second source as the representative source RS.

Specifically, the WTRU may receive a representative source RS indicator for each of configured TCI states.

In further embodiments, the WTRU may receive a representative source RS indicator for multiple TCI states which associated with each other. For example, a WTRU is configured with a first and a second TCI states. The first and the second TCI states are associated with each other. Each of the first and the second TCI states is associated with two source RSs. And: among the two RSs associated with the first TCI state and the two RS associated with the second TCI state, the WTRU is indicated by the network node at least a source RS to be the representative source RS; or

Specifically, the WTRU may receive a representative source RS indicator for each set of TCI states. Wherein a set of TCI states is interpreted as multiple TCI states which are associated with each others. For example, a WTRU is configured with a first, a second, a third and a fourth TCI states. The first and the second TCI states are associated with each other. The third and the fourth TCI states are associated with each other. Each of the first, second, third and fourth TCI states is associated with two source RSs. Furthermore: among the two RSs associated with the first TCI state and the two RS associated with the second TCI state, the WTRU is indicated by the network node with at least a source RS to be the representative source RS. Similarly, among the two RSs associated with the third TCI state and the two RS associated with the fourth TCI state, the WTRU is indicated by the network node at least a source RS to be the representative source RS; among the two RSs associated with the first TCI state, the WTRU is indicated by the network node with at least a source RS to be a first representative source RS. And among the two RSs associated with the second TCI state, the WTRU is indicated by the network node with at least a source RS to be one a second representative source RS. Wherein, WTRU applies both of the first and the second representative source RSs jointly for the TCI state selection related procedure(s). Similarly, among the two RSs associated with the third TCI state, the WTRU is indicated by the network node with at least a source RS to be a first representative source RS. And among the two RSs associated with the fourth TCI state, the WTRU is indicated by the network node with at least a source RS to be one a second representative source RS. Wherein, WTRU applies both of the first and the second representative source RSs jointly for the TCI state selection related procedure(s); and/or among all the RSs associated with the first, second, third and fourth TCI states, the WTRU is indicated by the network node with at least a source RS to be a representative source RS. for the TCI state selection related procedure(s).

### Implicit Approach

In one embodiment, a TCI state is configured to be associated with multiple source RSs that are indicated to be used for different types of QCL property estimation. Among the multiple source RSs, at least a source RS is indicated to be applied for a specific type of QCL property estimation. The source RS that is indicated to be applied for the specific type of QCL property estimation is implicitly determined by the WTRU as a representative source RS. Specifically, which type(s) of QCL property that is the specific type of QCL property may be either pre-indicated by the network node and/or defined in the specification. For example, in an embodiment, the specific type is (determined as) type-D. And a WTRU is configured with a TCI state which is associated with a first source RS and a second source RS. The first source RS is indicated by the network node to be applied for QCL type-A property estimation while the second RS is indicated by the network node to be applied for QCL type-D property estimation. In the embodiment, the WTRU determines the second source RS as the representative source RS.

In another embodiment, a TCI state is configured to be associated with multiple source RSs, wherein each is configured with a RS ID. Among the multiple source RSs, a source RS configured with a specific RS ID may be determined as the representative source RS. Wherein the RS ID may, but not limited to, be one or more alternative embodiments:
A RS ID with a largest value among all RS IDs associated with the multiple source RSs;
A RS ID with a smallest value among all RS IDs associated wit the multiple source RSs;
A RS ID with a value equal to or larger than a specific threshold;
A RS ID with a value equal to or smaller than a specific threshold;
A RS ID with a value within a specific range; and/or
A RS ID with a specific value.

It is noted that the threshold and/or the range and/or the specific value may be either pre-configured by the network node or pre-defined in the specification.

In further embodiments, a TCI state is configured to be associated with different types of source RSs. The WTRU implicitly determines which of the multiple source RSs that is a representative source RS based on the source RS's type. Wherein the type may be, but not limited to be, one or more of:
A source RS transmitted by a specific type of beam;
A source RS transmitted by a NF beam;
A source RS transmitted by a FF beam;
A source RS which is a SSB;
A source RS which is a CSI-RS.

In some other embodiments, a TCI state is configured to be associated with multiple source RSs via an IE carried by a RRC configuration. The WTRU determines which RS is the representative source RS based on the position of IEs in the RRC configuration. For example: A source RS configured by an IE in a first position of the RRC configuration, e.g., in a configured list of RSs, is determined as the representative source RS; and/or A source RS configured by an IE in a last position of the RRC configuration is determined as the representative source RS.

### Configuration of TCI Set

### Grouping of TCI States

To save (reduce) TCI state management overhead (e.g., saving signaling overhead), the network node may group multiple TCI states into a TCI set, and configure the WTRU accordingly. And the network node may switch the TCI status of the TCI states in a TCI set together, e.g., with a single indication. For example, the network node may group all TCI states associated with same spatial direction into a TCI set. Then active/deactivate the TCI states associated with same spatial direction together.

[Grouping Multiple TCI States as a TCI set/TCI Sub-Set, and Identification of NF/FF TCI State]

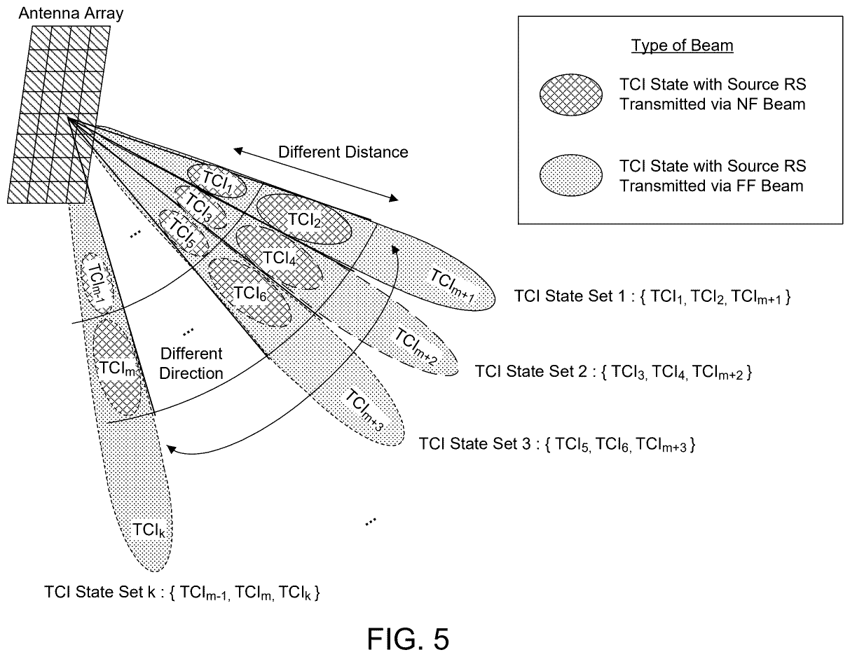

A WTRU may be configured, by a network node, with multiple TCI states via a downlink RRC message. One or more subset(s) of the configured multiple TCI states may additionally be indicated as one or more TCI set(s). That is, as shown in FIG. 5, the network node may indicate to the WTRU which of the multiple configured TCI states that are grouped as a TCI set. Wherein the TCI set here in the present disclosure may, but not limited to, be a logical group of TCI states which may be introduced for facilitating the operation of certain procedure(s). A WTRU may be configured with multiple TCI sets that each may consist of multiple TCI states.

Implementation of the TCI set technique may at least have the benefit of improving the efficiency of beam management, especially in NF deployment. For example, the network node may control the TCI state (de)activation on a per TCI set basis, which may save corresponding signaling overhead. It is noted that, the TCI set above may be, but not limited to be, configured and/or indicated by the network node via RRC, MAC CE and/or DCI.

There may be several alternative ways for a network node to configure TCI set(s) to a WTRU:
Explicit approaches:
In one embodiment, the WTRU is configured with multiple TCI states via RRC. The WTRU is further indicated by the RRC which of the multiple TCI states that are grouped as a TCI set;
In another embodiment, one or more, e.g., each, TCI state may be indicated with a TCI set ID. Based on a (value of) TCI set ID of a TCI state, the WTRU may determine which TCI set the TCI state belongs to. In other words, based on at least the (values of) TCI set IDs of each TCI state, the WTRU may determine which of the TCI states are within same TCI set.

Specifically, the TCI set ID may be configured by the network node via RRC signaling.

Specifically, the TCI set ID may be indicated by the network node via MAC CE;

Specifically, the TCI set ID may be indicated by the network node via DCI;

In a further embodiment (two-stage grouping mechanism), the WTRU is configured, by a RRC configuration, with multiple TCI states each is associated with a TCI state ID. Then, WTRU is further configured, via a MAC CE, with multiple of TCI state IDs. The WTRU determines which of the TCI states are grouped as TCI set(s) based on the RRC configuration and the MAC CE; Specifically, the MAC CE may carry multiple TCI state IDs which need to be added or removed from a TCI set; Specifically, the MAC CE may carry a TCI set ID indicating a TCI set;

Based on the introduced two stage grouping mechanism the TCI states of a TCI set may be dynamically updated in a shorter delay than reconfiguration by RRC.

In further embodiments (two-stage modification mechanism), the WTRU is configured, by a RRC configuration, with multiple TCI states where each is associated with a TCI state ID and a TCI set ID. Wherein the TCI set ID is to indicate WTRU which TCI set the corresponding TCI state belongs to. Then WTRU may further be indicated by the network node, via a MAC CE, to add/remove a TCI state into/from a TCI set. That is, there is an initial TCI set (configured by RRC) a TCI state belongs to. By receiving a MAC CE, the TCI state may be indicated to be:
removed from the initial TCI set;
added into another TCI set; and/or
switched from a first TCI set to another TCI set.

For example, a WTRU is configured, by RRC, with a first TCI state associated with a TCI state ID 1 and TCI set ID 1, a second TCI state associated with a TCI state ID 2 and TCI set ID 1, a third TCI state associated with a TCI state ID 3 and TCI set ID 2 and a fourth TCI state associated with a TCI state ID 4 and TCI set ID 2. The WTRU determines the TCI set 1 is the first and the second TCI states'initial TCI set and determines the TCI set 2 is the third and the fourth TCI states'initial TCI set. The WTRU may receive a MAC CE from the network node, and the MAC CE indicating WTRU:
to add the third TCI state and/or the fourth TCI state into TCI set 1;
to switch the third TCI state and/or the fourth TCI state from TCI set 2 to TCI set 1;
to remove the first TCI state and/or the second TCI state from TCI set 1.

It is noted that, an initial TCI set of a TCI state may be interpreted as a TCI set the TCI state belongs to.
Implicit approaches:
In one embodiment, the WTRU determines which of the configured TCI states that are grouped as a TCI set based on the source RSs associated with the TCI states;
In another embodiment, the WTRU determines which of the TCI states that are grouped as a TCI set based on RS IDs of the source RSs associated with the TCI states. For example, the WTRU determines the TCI set based on the value of the RS ID. For example, the WTRU determines that the TCI states which include source RSs with the same RS ID are grouped as a TCI set; For example, the WTRU determines that the TCI states which include source RSs with RS IDs within the same range of RS ID are grouped as a TCI set. Wherein the range may be either pre-configured by the network node or pre-defined in the specification;
In a further embodiment, the WTRU determines which of the TCI states that are grouped as a TCI set based on the type of source RSs that are associated with the TCI states, and/or based on the type of beams used to transmit the source RSs associated with the TCI states; Specifically, the WTRU determines that TCI states are grouped as a TCI set if the source RSs of the TCI states are transmitted by same type of beam (e.g., NF beam/FF beam); For example, the WTRU is configured with a first TCI state associated with a first source RS transmitted by a NF beam, a second TCI state associated with a second source RS transmitted by a NF beam, a third TCI state associated with a third source RS transmitted by a FF beam and a fourth TCI state associated with a fourth source RS transmitted by a FF beam. Then, the WTRU may determine the first and the second TCI states are grouped as a first TCI set and determine the third and the fourth TCI states are grouped as a second TCI set; Specifically, the WTRU determines TCI states are grouped as a TCI set if the source RSs of the TCI states are same type of RS (e.g., SSB/CSI-RS);
In further embodiments, the WTRU determines which of TCI states that are grouped as a TCI set based on an ID of a beam (the ID of RS associated with the beam) which is used to transmit the source RSs associated with the TCI states and/or based on a ID of a beam associated with the source RSs associated with the TCI states; For example, the WTRU is configured with a first TCI state associated with a first source RS transmitted by a beam associated with a beam ID 1, a second TCI state associated with a second source RS transmitted by a beam associated with a beam ID 1, a third TCI state associated with a third source RS transmitted by a beam associated with a beam ID 2 and a fourth TCI state associated with a fourth source RS transmitted by a beam associated with a beam ID 2. Then, the WTRU may determine the first and the second TCI states are grouped as a first TCI set and determine the third and the fourth TCI states are grouped as a second TCI set; It is noted that, in the present disclosure, a source RS transmitted by a beam associated with a beam ID may be interpreted as the source RS is transmitted by a beam, and the beam is associated with another beam identified by the beam ID.

In some other embodiments, the WTRU determines which of the TCI states that are grouped as TCI set/TCI sub-set based on the beam ID and the type of source RS; Specifically, the WTRU determines which of TCI states are grouped as TCI set based on the beam ID. The WTRU further determines, within the determined TCI set, which of the TCI states are grouped as TCI sub-set based on QCL type; For example, the WTRU is configured with a first TCI state associated with a first source RS transmitted by a first NF beam associated with a beam ID 1, a second TCI state associated with a second source RS transmitted by a second NF beam associated with a beam ID 1, a third TCI state associated with a third source RS transmitted by a third NF beam associated with a beam ID 1 and a fourth TCI state associated with a fourth source RS transmitted by a FF beam associated with a beam ID 1. The WTRU may determine the first, second, third and fourth TCI states are grouped as a TCI set since the four TCI states are associated with same beam ID. The WTRU further determines the first, second and the third TCI states are grouped as a first TCI sub-set of the TCI set since they are with same type of source RS (i.e., transmitted by same type of beam (NF beam)). And the WTRU determines the fourth TCI state is a second TCI sub-set of the TCI set since the fourth TCI state is with a type source RS different than the first TCI sub-set (i.e., transmitted by FF beam).

In some other embodiments, the WTRU determines which of the TCI states that are grouped as a TCI set based on QCL type of the source RSs associated with the TCI states. For example, the WTRU determines whether two TCI states are grouped as a TCI set based whether the source RSs of the two TCI states are configured for same type of QCL property; For example, the WTRU is configured with a first TCI state associated with a first source RS configured for a first type of QCL property, a second TCI state associated with a second source RS configured for a second type of QCL property and a third TCI state associated with a third source RS configured for a second type of QCL property. Then, the WTRU may determine that the second and the third TCI states are grouped as a TCI set since they have source RSs configured for same type of QCL property;

In a further embodiment, the WTRU determines which of the TCI states that are grouped as TCI set/TCI sub-set based on the QCL type and the beam ID; Specifically, the WTRU determines which of the TCI states that are grouped as TCI set based on the beam ID. The WTRU further determines, within the determined TCI set, which of the TCI states are grouped as TCI sub-set based on the type of source RS; For example, the WTRU is configured with a first TCI state associated with a first source RS for QCL type A and the first source RS is associated with a beam ID 1, a second TCI state associated with a second source RS for QCL type A and the second source RS is associated with a beam ID 1, a third TCI state associated with a third source RS for QCL type D and the third source RS is associated with a beam ID 1 and a fourth TCI state associated with a fourth source RS for QCL type D and the fourth source RS is associated with a beam ID 1. Then, the WTRU may determine the first, second, third and fourth TCI states are grouped as a TCI set since the four TCI states are associated with same beam ID. The WTRU further determines the first and second TCI states are grouped as a first TCI sub-set of the TCI set since they have sources RS for same type of QCL (i.e., type A). And the WTRU further determines the third and fourth TCI states are grouped as a second TCI sub-set of the TCI set since they have sources RS for same type of QCL (i.e., type D).

It is noted that, in the present disclosure, “a TCI state of a TCI set” may be interchangeable with “a TCI state within a TCI set”, “a TCI state belonging to a TCI set” and “a TCI state associated with a TCI set”.

In some other embodiments, the WTRU may determine a FF TCI state is associated with a NF TCI state if the FF TCI state having source RS associated with the NF TCI state. For example, the FF TCI state and the NF TCI state having a common source RS.

### Initial Status of TCI Set

### [All TCI States in a TCI Set May be Either in Same Status or in Different Status]

[TCI State (TCI Set) Status Configuration. That is, Before TCI Set Status Switching via an L2 or L1 Command, Each TCI Set is Indicated as in Either One of Active, Semi-Active or De-Active Status]

A WTRU may be configured by a network node, via a RRC message, one or more TCI set each contains one or more of TCI states. Each configured TCI set may be further indicated, by the network node, with an (initial) TCI set status (e.g., de-active, semi-active or active). Wherein the TCI set status may be but not limited to be indicated via the RRC message and may be switched/changed via L2 signaling. That is, the configured initial TCI set status may be further indicated to switch to other TCI set status by the network node via SSI and/or other downlink signaling.

In one embodiment, a TCI status of a TCI state belonging to a TCI set may be equal to a TCI set status of the TCI set. For example, a TCI state belongs to a TCI set, and the TCI set is indicated by the network node as in a semi-active status. Then, both of the TCI set and the TCI state are determined as in the semi-active status. Specifically, all TCI states in the TCI set are in the semi-active status;

### Configuration for TCI Selection

### TCI State/TCI Set/Source RS Selection Criteria

### [TCI State Selection Configuration]

A WTRU may be configured by network node with a TCI state selection configuration. Wherein the TCI state selection configuration may, but is not limited to, include one or more information listed below:
A TCI state selection criterion. For example, the TCI state selection criterion may, but is not limited to, be: whether the TCI state has a source RS for specific type of QCL property estimation; whether the TCI state is a specific type of TCI state (i.e., NF TCI state/FF TCI state); whether the source RS of the TCI state is a specific type of RS (e.g., SSB/CSI-RS);
A TCI state selection threshold. For example, the TCI state selection threshold may, but is not limited to, be: A RSRP threshold; A SINR threshold.

### [TCI Set Selection Configuration]

A WTRU may be configured by the network node with a TCI set selection configuration. Wherein the TCI set selection configuration may be but not limited to include one or more of the below listed information:
A representative TCI state;
A TCI set selection criterion. For example, the TCI set selection criterion may be, but is not limited to: whether the TCI set having at least a FF TCI state; whether the TCI set having at least a NF TCI state; whether the TCI set having at least a FF TCI state with a source RS configured for QCL-D; whether the TCI set having at least a first FF TCI state with a first source RS configured for QCL-D, and the first source RS is associated with or is same as a second source RS which is configured for a second FF TCI state. Wherein the second FF TCI state is within a TCI set which is currently be indicated as a specific TCI set status; and/or whether the TCI set having at least a NF TCI state associated with at least two FF TCI states;
A TCI set selection threshold. For example, the TCI set selection threshold may be but not limited to be: A RSRP threshold; A SINR threshold.

### TCI Management Enabling

### [Enabling Semi-Active TCI Status]

In one embodiment, the WTRU may be indicated by the network node, via individual RRC configuration, whether the semi-active TCI status and/or the semi-active TCI set status is enabled.

### [Enabling L1 Based TCI Status Switching]

In one embodiment, the WTRU may be indicated by the network node, via individual RRC configuration, whether a specific implicitly way of TCI status switching is enable or not. The implicitly way of TCI status switching may be either one of the embodiment introduced in section “preferred TCI state (TCI set) reporting” further on in this document.

### Preferred TCI State and TCI Set Determination

Since there may be a huge amount of TCI states be configured by the network node, it may be challenging for the network node to decide which of the huge amount of TCI states to activate. Hence, it will be beneficial if a WTRU reports which of the TCI states (or TCI sets) that are preferred to have a specific TCI status (or TCI set status).

That is, from a WTRU's perspective, after multiple TCI states are configured by the network node, the WTRU may determine which one or more of the multiple TCI states is preferred. Specifically, the WTRU may determine which one or more of the multiple TCI states that is preferred to be applied for corresponding downlink reception and/or uplink transmission. For example, a TCI state that is preferred by a WTRU may be interpreted as the TCI state that is with a source RS that is transmitted and focused on WTRU's spatial direction. More specifically, the WTRU may determine which one or more of the multiple TCI states that is preferred to be switched to a specific TCI status (i.e., active/semi-active/de-active).

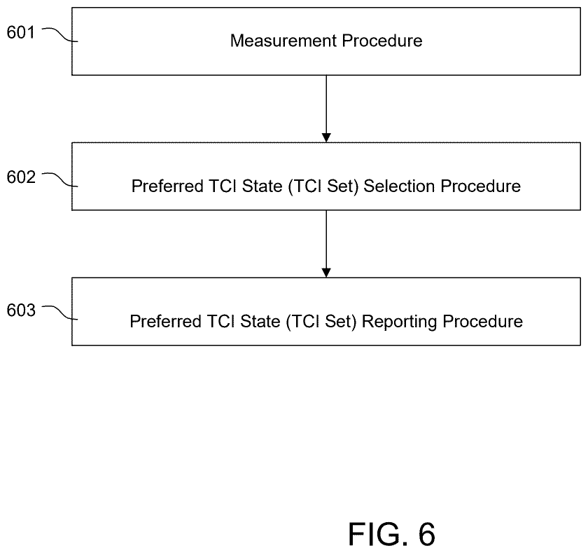

In one embodiment, as shown in FIG. 6, the WTRU may perform a specific measurement procedure (601) and may then perform a preferred TCI state (TCI set) selection procedure (602) (i.e., select one or more preferred TCI state (TCI set)) based on the (result of) the specific measurement procedure; After the WTRU has selected the preferred TCI state (TCI set), the WTRU may report (603) the selected TCI state (TCI set) to the network node.

### Measurement for Preferred TCI State (or TCI Set) Selection

To select a preferred TCI state among multiple (a plurality of) configured TCI states, a WTRU may perform a specific measurement procedure.

### [WTRU Measures Specific RS for Preferred TCI State (or TCI Set) Selection]

The specific measurement procedure mentioned above may be, but is not limited to, implemented as one or more of:
A) The WTRU measures one or more of source RS of either NF TCI state or FF TCI state. Specifically, the WTRU measures a source RS associated with NF TCI state or FF TCI state. For example, the WTRU is configured with multiple TCI states. The multiple TCI states including multiple NF TCI states and multiple FF TCI states. There may be some associations between each of the multiple NF TCI states and multiple FF TCI states. WTRU measures source RSs of either the multiple NF TCI states or the multiple FF TCI states. For example, in case the WTRU is configured with multiple TCI sets, each of the TCI sets consists of one or more of NF TCI states and one or more of FF TCI states. WTRU measures source RSs of either the one or more of NF TCI states or the one or more of FF TCI states.

More specifically, the WTRU may measure the source RS associated with NF TCI state or FF TCI state which is in a specific TCI status (either in de-active (inactive), semi-active or active status); For example, the WTRU may be configured with multiple TCI states. The multiple TCI states including multiple NF TCI states and multiple FF TCI states. There may be some associations between each of the multiple NF TCI states and multiple FF TCI states. And each of the multiple TCI states may be in either de-active, semi-active or active status. WTRU measures source RSs of either the multiple NF TCI states or the multiple FF TCI states which is in the specific TCI status.

More specifically, the WTRU may measure the source RS associated with a specific type of TCI state (i.e., NF TCI state or FF TCI state) of TCI set in a specific TCI set status (either de-active (inactive), semi-active or active status); For example, in case the WTRU is configured with multiple TCI sets, each of the TCI sets consists of one or more NF TCI states and one or more FF TCI states. Each of the TCI sets may have a separate TCI set status. WTRU measures source RSs of either the one or more NF TCI states or the one or more FF TCI state of TCI sets in the specific TCI set status.
B) In one embodiment, the WTRU may measure one or more source RS(s) configured for specific type of QCL property (e.g., QCL type A, B, C and/or D) estimation; For example, the WTRU is configured with multiple TCI states. Each of the multiple TCI states may be configured with different source RSs for different types of QCL property estimation. The WTRU measures the source RSs for specific type of QCL property estimation. For example, in case the WTRU is configured with multiple TCI sets, each of the TCI sets consists of one or more TCI states. Each of the one or more TCI states may be configured with different source RSs for different types of QCL property estimation. The WTRU measures the source RSs for specific type of QCL property estimation.

More specifically, the WTRU may measure one or more source RS(s) of TCI states which in a specific TCI status. And the one or more source RS(s) may be configured for specific type of QCL property estimation; For example, the WTRU is configured with multiple TCI states. Each of the multiple TCI states may be configured with different source RSs for different types of QCL property estimation. And each of the multiple TCI states may be in different TCI status. The WTRU measures the source RSs of TCI state in the specific TCI status and the source RS are for specific type of QCL property estimation.

More specifically, the WTRU may measure on one or more source RS(s) of TCI state(s) in TCI set which in a specific TCI set status. And the one or more source RS(s) is configured for specific type of QCL property estimation; For example, in case of TCI set is implemented and the WTRU is configured with multiple TCI sets. Each of the TCI sets consists of one or more TCI states. Each TCI set may be in different TCI status. Each of the one or more TCI states may be configured with different source RSs for different types of QCL property estimation. The WTRU measures the source RSs for specific type of QCL property estimation and the source RSs are associated with TCI set in the specific TCI set status.
C) In one embodiment, the WTRU may measure one or more specific RS configured to associate with a TCI state; For example, the WTRU is configured with multiple TCI states. Each of the multiple TCI states may be configured with an individual RS (for preferred TCI state selection). The WTRU measures each of the individual RSs associated with the multiple TCI states. For example, in case of TCI set is implemented and the WTRU is configured with multiple TCI sets. Each of the TCI sets consists of one or more TCI states. Each of the multiple TCI sets may be configured with an individual RS (for preferred TCI set selection). The WTRU measures each of the individual RSs associated with the multiple TCI sets.

More specifically, the WTRU may measure one or more specific RS configured to associate with a TCI state, and the TCI state in a specific TCI status; For example, the WTRU is configured with multiple TCI states. Each of the multiple TCI states may be in different TCI status. Each of the multiple TCI states may be configured with an individual RS (for preferred TCI state selection). The WTRU measures each of the individual RSs associated with the multiple TCI states which is in the specific TCI status.

More specifically, the WTRU may measure on one or more specific RS configured to associate with a TCI set which in a specific TCI set status; For example, in case of TCI set is implemented and the WTRU is configured with multiple TCI sets. Each of the multiple TCI sets may be in different TCI set status. Each of the TCI sets consists of one or more TCI states. Each of the multiple TCI sets may be configured with an individual RS (for preferred TCI set selection). The WTRU measures each of the individual RSs associated with the multiple TCI sets which is in the specific TCI set status.

It is noted that, all the measurements on RS mention above may also include the WTRU measuring the RSRP, SINR and/or some other criteria on the RS.

### [General Two-Stage Measurement]

The specific measurement procedure mentioned above may, but is not limited to, be implemented as a two-stage measurement as one or more of:
The WTRU performs a two-stage measurement on one or more RS;
The WTRU performs a 1st stage measurement on source RSs associated with a first type of TCI states (e.g., NF TCI state/FF TCI state), and then performs a 2nd stage measurement on source RSs associated with a second type of TCI states;
The WTRU performs a 1st stage measurement on source RSs associated with a first type of TCI states, and then performs a 2nd stage measurement on source RSs associated with a second type of TCI states, wherein the second type of TCI states measured by the WTRU in the 2nd stage are associated with the first type of TCI states measured by the WTRU in the 1st stage; and/or The WTRU performs a 1st stage measurement on source RSs associated with a first type of TCI states, and then performs a 2nd stage measurement on source RSs associated with a second type of TCI states, wherein the TCI states measured by the WTRU in the 2nd stage are selected by the WTRU based on the 1st stage measurement;

For example, in the 1st stage measurement, the WTRU measures specific source RSs of FF TCI states, wherein the specific source RS may, but is not limited to, be QCL type D source RS. In the 2nd stage measurement, WTRU measures source RSs of NF TCI states which are associated with specific FF TCI state(s). Wherein the specific FF TCI states may be:
the FF TCI states applied for source RSs measurement in the 1st stage;
a subset of the FF TCI states applied for source RSs measurement in the 1st stage;
a subset of the FF TCI states applied for source RSs measurement in the 1st stage, and the subset is determined and selected by the WTRU;
a subset of the FF TCI states applied for source RSs measurement in the 1st stage, and the subset is determined and selected by the WTRU based on the result of the 1st stage measurement; and/or
a subset of the FF TCI states applied for source RSs measurement in the 1st stage, and the subset is determined and selected by the WTRU based on the result of the 1st stage measurement and one or more TCI state selection criteria configured by the network node;

According to another example, in the 1st stage measurement, the WTRU measures QCL type D source RSs of FF TCI states. In the 2nd stage measurement, WTRU measures QCL type A, B or C RS source RSs of NF TCI states which associated with the FF TCI state(s).

It is noted that the TCI states measured in the 2nd stage may be selected by the WTRU based on the measurement performed in the 1 st stage.

### [NF/FF Hybrid Two-Stage Measurement]

In case a WTRU is configured with multiple TCI sets, each of the configured TCI sets consists of one or more NF TCI states and one or more FF TCI states multiple TCI states. The specific measurement procedure mentioned above may, but is not limited to, be implemented as a NF/FF hybrid two-stage measurement as one or more of:
The WTRU performs a two-stage measurement on one or more RS;
The WTRU performs a 1st stage measurement on source RSs associated with a first type of TCI state (e.g., NF TCI state/FF TCI state) belongs to each of the multiple TCI sets, and then performs a 2nd stage measurement on source RSs associated with a second type of TCI state that belongs to each of the multiple TCI sets;
The WTRU performs a 1st stage measurement on source RSs associated with a first type of TCI states belongs to each of the multiple TCI sets, and then performs a 2nd stage measurement on source RSs associated with a second type of TCI states belongs to each of the multiple TCI sets, wherein the TCI states measured by the WTRU in the 2nd stage are selected by the WTRU based on the 1st stage measurement; and/or

The WTRU performs a 1st stage measurement on source RSs associated with a first type of TCI states belongs to each of the multiple TCI sets, and then selects K TCI sets based on the measurement result of the 1st stage measurement. WTRU performs a 2nd stage measurement on source RSs associated with a second type of TCI states belongs to each of the K TCI sets. In another embodiment, the K TCI may be selected by the WTRU based on the 1st stage measurement and one or more TCI set selection criteria configured by the network node.

For example, a WTRU is configured with multiple TCI sets. Each TCI set may consist of at least one FF TCI state and a NF TCI state. Each of the NF TCI state and the FF TCI state is configured with a first source RS for QCL type A property estimation, and a second source RS for QCL type D property estimation. It is noted that, a first source RS of a first TCI state may be different than a first source RS of a second TCI state. And a second source RS of a first TCI state may be different than a second source RS of a second TCI state. In the 1st stage measurement, the WTRU measures on first type of source RSs of FF TCI states of the multiple TCI sets, wherein the first type of source RS may be but not limited to be QCL type D RS. In the 2nd stage measurement, WTRU measures on second type of source RSs of NF TCI states of the each of the multiple TCI sets. The second type of source RSs may be but not limited to be QCL type A/B/C source RS. Wherein:
The WTRU selects K TCI set(s) based on the 1st stage measurement;
In the 2nd stage measurement, the WTRU measures source RS(s) of NF TCI state(s) that belong to each of the K TCI sets which the WTRU selected based on the 1st stage measurement.

### Determination of Preferred TCI State (Set)

As addressed above, after performing the specific measurement procedure introduced earlier, the WTRU may perform the preferred TCI state (TCI set) selection procedure to select preferred TCI state (TCI set) among multiple configured TCI states (TCI sets).

### [General Preferred TCI State Selection]

The specific preferred TCI state selection procedure mentioned above may, but is not limited to, be implemented as one or more of:
A) The WTRU performs the preferred TCI state selection procedure and selects at least one preferred TCI state from the multiple configured TCI states which is in a specific TCI status (i.e., de-active/semi-active/active); that is, only the TCI state in the specific status can be selected by the WTRU as preferred TCI state;
B) Among the configured multiple TCI states, the WTRU selects at least one preferred TCI state based on: the measurement result from the specific measurement procedure; one or more of TCI state selection criteria; and/or one or more TCI state selection threshold;
C) In one embodiment, the WTRU is configured with a TCI state selection threshold. In this example, the TCI state selection threshold is configured as a RSRP threshold. WTRU performs the specific measurement procedure to obtain measurement results corresponding to each of the multiple configured TCI states. The WTRU checks whether measurement results corresponding to each of the multiple configured TCI states meets the TCI state selection threshold or not. Among the multiple configured TCI states, a TCI state can be determined as a preferred TCI state only when at least a measurement result corresponding to the TCI state meets the TCI state selection threshold. For example, the measurement result corresponding to a TCI state may be a first RSRP value. And the TCI state selection threshold may be a second RSRP value. The TCI state can be determined as a preferred TCI state only when at least the first value is equal to or higher than the second value.
D) In one embodiment, the WTRU is configured with a TCI state selection criteria and a TCI state selection threshold. In this example, the TCI state selection criteria is configured as a specific type of QCL property and a specific type of TCI state (i.e., NF TCI state/FF TCI state). The TCI state selection threshold is configured as a RSRP threshold. WTRU performs the specific measurement procedure to obtain measurement results corresponding to each of specific TCI state(s) within the multiple configured TCI states. Wherein the specific TCI state(s) is determined by checking the TCI state selection criteria. Wherein the specific TCI state(s) may be interpreted as the TCI state having source RS for the specific type of QCL, and the TCI state is associated with the specific type of beam (i.e., the TCI state is the NF TCI state or the FF TCI state). WTRU checks whether measurement results corresponding to each of the specific TCI states meets the TCI state selection threshold or not. Among the multiple specific TCI states, a TCI state can be determined as a preferred TCI state only when at least a measurement result corresponding to the TCI state meets the TCI state selection threshold. For example, the TCI state selection criteria is configured as a QCL type D and FF TCI state. The WTRU may only need to perform the specific measurement procedure on the TCI state(s) having source RS for QCL type D and the TCI state is FF TCI state. The measurement result corresponding to a TCI state may be a first RSRP value. And the TCI state selection threshold may be a second RSRP value. The TCI state can be determined as a preferred TCI state only when at least: the TCI state having source RS for QCL type D and the TCI state is FF TCI state, and the first value is equal to or higher than the second value.

### [General Preferred TCI Set Selection]

The specific preferred TCI set selection procedure mentioned above may, but is not limited to, be implemented as one or more of:
A) WTRU performs the preferred TCI set selection procedure and selects at least one preferred TCI set from the multiple configured TCI sets which is in a specific TCI set status (i.e., de-active/semi-active/active); That is, only the TCI set in the specific status can be selected by the WTRU as preferred TCI state;
B) Among the configured multiple TCI sets, WTRU selects at least one preferred TCI set based on: the measurement result from the specific measurement procedure; one or more TCI set selection criteria; and/or one or more TCI set selection threshold;
C) In one embodiment, the WTRU is configured with a TCI set selection threshold. In this example, the TCI set threshold is configured as a RSRP threshold. WTRU performs the specific measurement procedure to obtain measurement results corresponding to each of the multiple configured TCI sets. The WTRU checks whether measurement results corresponding to each of the multiple configured TCI sets meets the TCI set selection threshold or not. Among the multiple configured TCI set, a TCI set can be determined as a preferred TCI set only when at least a measurement result corresponding to the TCI set meets the TCI set selection threshold;

For example, the specific measurement procedure for a TCI set may include the WTRU only measure RS associated with a subset of TCI state(s) within the TCI set; For example, the specific measurement procedure for a TCI set may include the WTRU measure source RSs of all TCI states in the TCI set; For example, the specific measurement procedure for a TCI set may include the WTRU measure source RSs of all NF TCI states in the TCI set; For example, the specific measurement procedure for a TCI set may include the WTRU measure source RSs of all FF TCI states in the TCI set;
D) In another embodiment, to reduce the number of source RS needs to be measured for preferred TCI set selection, the WTRU is configured with a TCI set selection threshold and a representative TCI state configuration. In this example, the TCI set threshold is configured as a RSRP threshold. WTRU performs the specific measurement procedure to obtain measurement results corresponding to each of specific TCI state, determined based on the representative TCI state configuration, of the multiple configured TCI sets. The WTRU checks whether measurement results corresponding to each of the multiple configured TCI sets meets the TCI set selection threshold or not. Among the multiple configured TCI set, a TCI set can be determined as a preferred TCI set only when at least a measurement result corresponding to the TCI set meets the TCI set selection threshold;
E) In one embodiment, to reduce the number of source RS needs to be measured for preferred TCI set selection, the WTRU is configured with a TCI set selection criteria and a TCI set selection threshold. Similar as above, the WTRU selects a specific sub-set of TCI sets among the multiple configured TCI sets based on the TCI set selection criteria. For example, a TCI set meets the TCI set selection criteria means the TCI set consists of at least a TCI state associates with a source RS which is same as a source RS of a TCI state with active status. The TCI state selection threshold is configured as a RSRP threshold. WTRU performs the specific measurement procedure to obtain measurement results corresponding to each of TCI sets within the specific sub-set of TCI sets. WTRU checks whether measurement results corresponding to each of the specific TCI sets meets the TCI state selection threshold or not. Among the multiple specific TCI sets, a TCI set can be determined as a preferred TCI set only when at least a measurement result corresponding to the TCI set meets the TCI state selection threshold.

### [Two Thresholds Selection]

In one embodiment, the WTRU is configured with a first TCI set selection threshold and a second TCI set selection threshold. In this example, the first TCI set selection threshold and the second TCI set selection threshold are configured as RSRP threshold. WTRU performs the specific measurement procedure to obtain measurement results corresponding to each of the multiple configured TCI sets. The WTRU checks whether measurement results corresponding to each of the multiple configured TCI sets meets the first and the second TCI set selection thresholds or not. Different from the embodiment mentioned above, among the multiple configured TCI set, a TCI set can be determined as a preferred TCI set only when at least: a measurement result of a TCI state within the TCI set meets the first TCI set selection threshold; and/or measurement results of more than m TCI state(s) within the TCI set meets the second TCI set selection threshold.

### [Two-Stages Selection]

In one embodiment, to have more accurate TCI set selection, the WTRU is configured with a first TCI set selection threshold and a second TCI set selection threshold. In this example, the first TCI set selection threshold and the second TCI set selection threshold are configured as RSRP threshold. WTRU performs the specific measurement procedure to obtain measurement results corresponding to each of the multiple configured TCI sets. The WTRU checks whether measurement results corresponding to each of the multiple configured TCI sets meets the first and the second TCI set selection thresholds or not. Different from the embodiments mentioned above, among the multiple configured TCI set, a TCI set can be determined as a preferred TCI set only when at least: a measurement result of a FF TCI state within the TCI set meets the first TCI set selection threshold; and/or measurement results of NF TCI state(s) within the TCI set meets the second TCI set selection threshold.

### Preferred TCI State (TCI Set) Reporting

Based on the procedure introduced earlier in the present disclosure, the WTRU may determine a preferred TCI state and/or a preferred TCI set. The WTRU may further report the determined preferred TCI state and/or preferred TCI set to the network node via either RRC, MAC CE or L1 signaling.

The reporting may carry at least, but is not limited to, the information listed as follows: TCI state ID; TCI set ID.

In some other embodiments: the WTRU may report which of the TCI states that are preferred to be grouped as a TCI set; the WTRU may report which of the TCI state(s) that is preferred to be added into a TCI set; the WTRU may report which of the TCI state(s) that is preferred to be removed from a TCI set.

### WTRU Provides Input to Assist Network Node to Select a TCI Set

[WTRU Indicates Network Node Which TCI State (Set) is Preferred to be Switched to Either Active or Semi-Active Status Via Uplink Signaling (e.g., L1 and/or L2)]

In one embodiment, the WTRU is configured with multiple TCI states via RRC. Among the multiple TCI states, the WTRU is further indicated to switch one or more TCI states to a first TCI status. Based on either the preferred TCI state selection procedure disclosed above, or some other methods, the WTRU reports which TCI state(s) in the first TCI status is preferred to be switched to a second TCI status.

In another embodiment, the WTRU is configured with multiple TCI sets via RRC. Among the multiple TCI sets, the WTRU is further indicated to switch one or more TCI sets to a first TCI set status. Based on either the preferred TCI set selection procedure disclosed above, or some other methods, the WTRU reports which TCI set(s) in the first TCI set status is preferred to be switched to a second TCI set status.

### Frequency of Reporting

### [Triggering of WTRU Provides Preferred TCI State to Network Node; e.g., Event-Based Triggered, Periodic Triggered.]

In one embodiment, the WTRU may periodically report the preferred TCI state (TCI set) to the network node. Specifically, the WTRU may be configured by the network node with a specific time length (e.g., periodicity). The WTRU may determine to triggering a preferred TCI state (TCI set) reporting procedure (e.g., report transmission on a periodic uplink resource) if the time elapses since last reporting is equal to the specific time length.

More specifically, the WTRU may be configured by the network node with a specific time length (duration). The WTRU may (re)start a preferred TCI state reporting timer. The WTRU may determine to trigger a preferred TCI state (TCI set) reporting procedure in response to the preferred TCI state reporting time expired.

It is noted that the time length (duration) may be either in unit of symbol, sub-slot, slot, sub-frame, frame or ms;

### TCI Status (TCI Set Status) Indication

### [TCI Status (TCI Set Status) Switching]

According to the embodiments introduced earlier in the present disclosure, both of the TCI state and TCI set may dynamically be switched among three statuses: active, semi-active and de-active (inactive). There may be several alternative embodiments in regards of how to determine to switch the TCI status and the TCI set status list as follows.

The WTRU may be indicated by the network node with a SSI (status switching indicator). The received SSI may indicate to the WTRU to switch one or more TCI state to a specific TCI status (determined/indicated based on the TCI status indicator). Wherein the TCI status indicator may, but is not limited to, be carried by a RRC message, a MAC CE or a DCI; It is noted that the TCI status indicator may also be applied for indicating the switching of TCI set status. That is, the WTRU may be indicated by the network node with a TCI status indicator. The received TCI status indicator may indicate to the WTRU to switch one or more TCI set to a specific TCI set status.

Specifically, the status switching indicator may carry one or more of the following pieces of information:
TCI state indicator indicating which TCI state needs to switch to a target TCI status;
An index of a TCI state among a set of TCI states, wherein the set of TCI states may comprise TCI states with the same TCI status. For example, if the WTRU has 8 TCI states with a first TCI status, and the indicator indicates a switch from a first TCI status to a second TCI status, the indicator may also comprise one or more indices that may select from the 8 TCI states;
TCI set indicator indicating which TCI set need to switch to a target TCI set status;
TCI status indicator indicating which target TCI status the corresponding TCI state should be switched to;
TCI set status indicator indicating which target TCI set status the corresponding TCI set should be switched to.

Wherein the status switching indicator and the information mentioned above may, but is not limited to, be carried by RRC, MAC CE and/or DCI.

In one embodiment, a TCI state indicator (TCI set indicator) indicating a TCI state ID (TCI set ID) of a TCI state (TCI set) which may be configured by RRC.

In another embodiment, a TCI state indicator and/or TCI set indicator may comprise multiple bits, wherein:
A) a position of each bit within the multiple bits implicitly associates with a specific TCI state (or a specific TCI set);
B) a position of each multiple bits within the multiple bits implicitly associates with a specific TCI state (or a specific TCI set); For example, the TCI state indicator having 4 bits (i.e., b1, b2, b3, and b4). Each of two bits are associated with a specific TCI state (TCI set). That is, first two bits (i.e., b1 and b2) are associated with a first TCI state (TCI set), and following two bits (i.e., b3 and b4) are associated with a second TCI state (TCI set).
C) The specific TCI state (specific TCI set) may be but not limited to be one of TCI state (TCI set) pre-configured by RRC; and/or
D) The specific TCI state (specific TCI set) may, but is not limited to, be one of TCI state (TCI set) pre-configured by RRC and with a specific TCI status (TCI set status); For example, the TCI state indicator having 4 bits (i.e., b1, b2, b3, and b4). The first two bits (i.e., b1 and b2) are associated with a first TCI state (TCI set) with active status, and following two bits (i.e., b3 b4) are associated with a second TCI state (TCI set) with active status. Wherein the first and the second TCI state may be determined based on the value of the TCI state ID (TCI set ID). For example, the TCI state (TCI set) with active status having a lowest TCI state ID (e.g., lowest/smallest number) (TCI set ID) may be determined as the first TCI state (TCI set), and the TCI state (TCI set) with active status having a second lowest/smallest TCI state ID (TCI set ID) may be determined as the second TCI state (TCI set).

In further embodiments, a status switching indicator may consist of one or multiple of TCI status indicator(s) and/or TCI set status indicator(s):
Each of the one or multiple of TCI status indicators may be associated with a TCI state;
Each of the one or multiple of TCI status indicators may be associated with a TCI state with a specific TCI status;
Each of the one or multiple of TCI set status indicators may be associated with a TCI set;
Each of the one or multiple of TCI set status indicators may be associated with a TCI set with a specific TCI set status;
A value of a TCI status indicator (TCI set status indicator) indicating a target TCI status (TCI set status) to which the corresponding TCI state (TCI set) should switch: for example, when the TCI status indicator (TCI set status indicator) is set to a first value, indicating the WTRU should switch the corresponding TCI state (TCI set) to a first TCI status (first TCI set status); for example, when the TCI status indicator (TCI set status indicator) is set to a second value, indicating the WTRU should switch corresponding TCI state (TCI set) to a second TCI status (second TCI set status).

It is noted that, based on embodiments introduced for the status switching indicator above, the WTRU may receive a MAC CE (i.e., the MAC CE carrying the status switching indicator) from the network node, and the MAC CE includes a first TCI set status indicator. The TCI set status indicator indicates WTRU to switch a first TCI set to active status, and to switch at least one second TCI set to semi-active status. Following this, the WTRU may receive a DCI carrying a second TCI set status indicator. The second TCI set status indicator indicating to switch one of the at least one second TCI set with semi-active status to active status. And the second TCI set status indicator may also indicate the WTRU to switch the first TCI set with active status to either semi-active status or de-active status.

In one example, a WTRU receives a MAC CE from a network node, the MAC CE is with a specific Logical Channel Identity (LCID). The MAC CE consists at least a TCI state indicator (TCI set indicator). The WTRU determines that at least a TCI state (TCI set) needs to switch to a target TCI status (TCI set status) based on the MAC CE. Specifically: The at least a TCI state (TCI set) is determined based on the at least a TCI state indicator (TCI set indicator); and/or the target TCI status (TCI set status) is determined based on the LCID. That is, the WTRU distinguishes which TCI status (TCI set status) is switched, based on the value of the LCID of the MAC CE (e.g., different LCIDs for different TCI status (TCI set status).

In one embodiment, to limit (reduce) the bit-width of the TCI status indicator, i.e. to keep the number of bits required for the TCI status indicator low (TCI set status indicator), the TCI status indicator(s) (TCI set status indicator(s)) may only be able to indicate two of the active, semi-active and de-active status. That is, the WTRU may be configured with multiple TCI states (TCI sets) by RRC, and a subset of the multiple TCI states (TCI sets) are indicated, by a first MAC CE, to switch to first TCI status (first TCI set status). The WTRU may receive a second MAC CE which carries at least a TCI status indicator(s) (TCI set status indicator(s)). The at least a TCI status indicator(s) (TCI set status indicator(s)) indicates either a second or a third TCI status (TCI set status) for the subset of the multiple TCI states (TCI sets). That is, the TCI status indicator(s) (TCI set status indicator(s)) carried by the second MAC CE may only be able to indicates TCI status (TCI set status) which are different than the first TCI status (TCI set status). In another embodiment, the TCI status indicator(s) (TCI set status indicator(s)) may be carried by a DCI. By these embodiments, a network node may only need one bit to indicates WTRU to switch TCI status (TCI set status).

E.g., the WTRU is configured with 128 TCI states by RRC. The WTRU is indicated to switch 8 of the 128 TCI states to active status by a first MAC CE. The WTRU may be indicated to switch one of the 8 active TCI states to semi-active or de-active status by a 1-bit TCI status indicator carried by a second MAC CE. Wherein there are eight 1-bit TCI status indicators carried by the second MAC CE. Each of the 1-bit TCI status indicators is associated with one of the 8 TCI states indicated by the first MAC CE based on the position of the 1-bit TCI status indicators in the second MAC CE and the TCI state ID of the 8 TCI states. For example, the 1-bit TCI status indicator set to “0” indicating semi-active status, and the 1-bit TCI status indicator set to “1” indicating de-active status. It is noted that, the WTRU may be indicated with a multi-bit TCI status indicator by the second MAC CE. Each bit of the multi-bit TCI status indicator is associated with one of the 8 active TCI states. Each bit of the multi-bit TCI status indicator indicating semi-active or de-active status for corresponding associated TCI state.

E.g., the WTRU is configured with 16 TCI sets by RRC. The WTRU is indicated to switch 8 of the 16 TCI sets to active status by a first MAC CE. The WTRU may be indicated to switch one of the 8 active TCI sets to semi-active or de-active status by a 1-bit TCI set status indicator carried by a second MAC CE. Wherein there are eight 1-bit TCI set status indicators carried by the second MAC CE. Each of the 1-bit TCI set status indicators is associated with one of the 8 TCI sets indicated by the first MAC CE based on the position of the 1-bit TCI set status indicators in the second MAC CE and the TCI set ID of the 8 TCI sets. For example, the 1-bit TCI set status indicator set to “0” indicating semi-active status, and the 1-bit TCI set status indicator set to “1” indicating de-active status. It is noted that, the WTRU may be indicated with a multi-bits TCI set status indicator by the second MAC CE. Each bit of the multi-bits TCI set status indicator is associated with one of the 8 active TCI sets. Each bit of the multi-bits TCI set status indicator indicating semi-active or de-active status for corresponding associated TCI set.

To save (reduce) signaling overhead, a network node may indicate to a WTRU to switch TCI status of a set of TCI states together via a single indicator (a.k.a. TCI set status indicator). Furthermore, the network node may indicate WTRU to switch TCI status of two sets of TCI states via a single indicator. For example, by using the single indicator, the WTRU may be indicated to exchange TCI set status of the two sets of TCI states. To save the processing delay on the single indicator, the single indicator may be carried by a DCI.

In a further embodiment, a WTRU may receive a MAC CE carrying the status switching indicator from a network node. Wherein the status switching indicator consists of multiple of TCI state indicators (TCI set indicators). A position of a TCI state indicator (a TCI set indicator), within the MAC CE, indicating the WTRU the TCI state (TCI set) identified by the TCI state indicator (TCI set indicator) needs to be switched to either active status or semi-active status.

For example, there are four TCI state indicators (1st, 2nd, 3rd and 4th) carried by the status switching indicator (or the MAC CE). The 1st, 2nd, 3rd and 4th TCI state indicators are sequentially contained in the MAC CE. Each of the 1st, 2nd, 3rd and 4th TCI state indicator indicating a TCI state out of a list of TCI states which be pre-configured by RRC;

For example, the WTRU determines that, among the four TCI states identified by the four TCI state indicators, the first K TCI states (identified by the 1st to Kth TCI state indicators) are in active (or semi-active) status, and the WTRU determines that the remaining (4-K) are in semi-active (active) status;
wherein the K may be indicated by the MAC CE or pre-defined in the specification;
wherein the WTRU may report the K related capability to the WTRU during WTRU capability reporting.

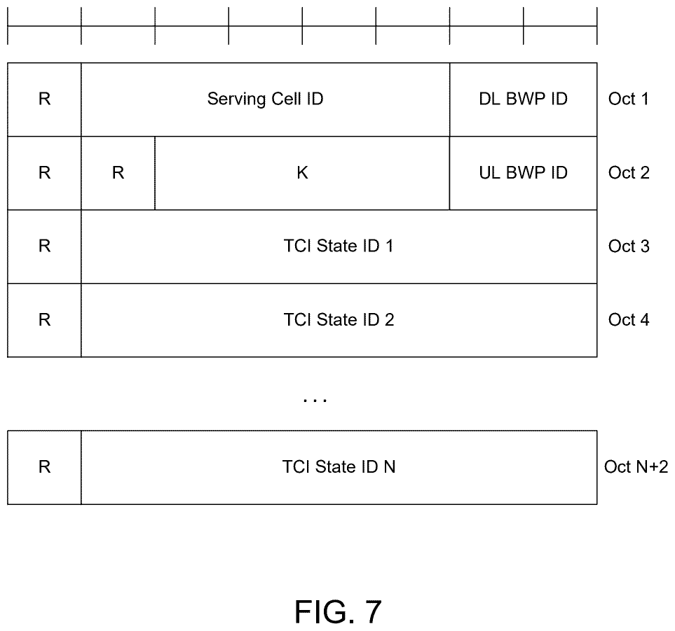

For example, as illustrated in FIG. 7, the MAC CE carrying the status switching indicator has a variable size and may comprise the following fields:
Serving Cell ID: This field indicates the identity of the Serving Cell for which the MAC CE applies. The length of the field is, for example, 5 bits;
DL BWP ID/UL BWP ID: This field indicates a DL/UL BWP for which the MAC CE applies as the codepoint of the DCI bandwidth part indicator field as specified in TS 38.212. The length of the BWP ID field is, for example, 2 bits;
TCI state ID N: This field indicates the Nth TCI state identified by TCI state ID as indicated by RRC.
K: This field indicates a number of TCI state needs to be switched to active status. The TCI states with TCI state ID 1 to TCI state ID K needs to be switched to active (semi-active) status. The TCI states with TCI state ID K+1 to TCI state ID N needs to be switched to semi-active (active) status.
R: Reserved bit, e.g., set to 0.

It is noted that the WTRU may report a capability to a network node indicating the maximum/minimum number of K can be applied.

In another further embodiment, a WTRU may receive, from a network node, a MAC CE carrying the status switching indicator. Wherein the status switching indicator consists of multiple first (i.e., N1) TCI status indicators (or TCI set status indicators) and one or more of second (i.e., N2) TCI status indicator(s) (or TCI set status indicator(s)). Wherein the N1 is equal to the number of TCI states pre-configured by the RRC. Each of the N1 TCI status indicators (or TCI set indicators) is associated with a TCI state (or TCI set). A position of a TCI status indicator (or a TCI set status indicator) of the N1 TCI status indicator (or TCI set indicators), within the MAC CE, indicating which TCI state (or TCI set) the TCI status indictor (the TCI set status indicator) is associated with. The WTRU may be indicated with M1 TCI states (TCI sets) by the N1 TCI status indicators (TCI set status indicators). And the WTRU may determine a TCI status (TCI set status) for each of the M1 TCI states (TCI sets) based on the N2 TCI status indicators (TCI set status indicators). Afterward, the WTRU may switch the each of the M1 TCI states (TCI sets) to corresponding TCI status (TCI set status).

Specifically, the N2 may be equal to M1;

Specifically, each of the M1 TCI states (TCI sets) is associated with one of the N2 TCI status indicators (TCI set status indicators);

Specifically, each of the M1 TCI states (TCI sets) is determined to be associated with one of the N2 TCI status indicators (TCI set status indicators) based on the position of M1 TCI states (TCI sets) corresponding TCI status indicators (TCI set status indicators) in the MAC CE; For example, a first TCI status indicator identifies a first of the M1 TCI state, and the first of the M1 TCI state is associated with a first of the N2 TCI status indicators. A second TCI status indicator identifies a second of the M1 TCI state, and the second of the M1 TCI state is associated with a second of the N2 TCI status indicators, and so on.

According to further embodiments, a WTRU may receive a MAC CE carrying the status switching indicator from a network node. Wherein the status switching indicator consists of a first TCI status indicators (TCI set status indicators) having N1 bits and a second TCI status indicators having N2 bits. Each bit of the N1 bits is associated with one TCI state (TCI set) configured by the RRC, e.g., in order of TCI state Id. WTRU will be indicated with M1 TCI states (TCI sets) by the M1 bits of the N1 bits. Each bit of the N2 bits will be applied, by the network node, to indicate a TCI status (TCI set status) for one of the M1 TCI states (TCI sets). For example, the first bit of the N2 bits is applied to indicate a TCI status (TCI set status) of a first TCI state (TCI set) of the M1 TCI states (TCI sets), e.g., the TCI state with lowest TCI state Id among the M1 TCI states. And the second bit of the N2 bits is applied to indicate a TCI status (TCI set status) of a second TCI state (TCI set) of the M1 TCI states (TCI sets), e.g., the TCI state with second lowest TCI state Id among the M1 TCI states, and so on.

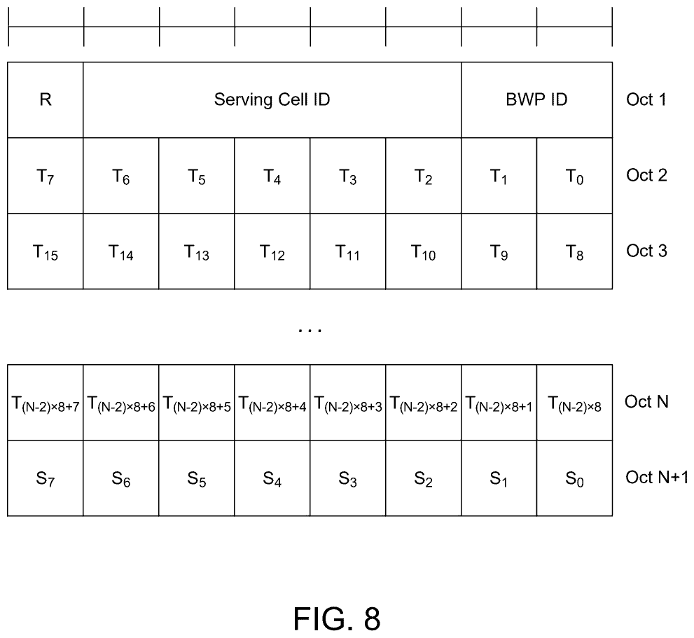

For example, as illustrated in FIG. 8, the MAC CE carrying the status switching indicator has a variable size consisting of following fields:
Serving Cell ID: This field indicates the identity of the Serving Cell for which the MAC CE applies. The length of the field is, for example, 5 bits;
BWP ID: This field indicates a DL/UL BWP for which the MAC CE applies as the codepoint of the DCI bandwidth part indicator field as specified in TS 38.212. The length of the BWP ID field is, for example, 2 bits;
Ti: The first TCI status indicator. If there is a TCI state with TCI state ID I (configured by RRC), this field indicates whether the TCI state with TCI state ID i is indicated with a TCI status by this MAC CE, otherwise WTRU shall ignore the Ti field. The Ti field is set to 1 to indicate that the TCI state with TCI state ID i is indicated with a TCI status by S field. The Ti field is set to 0 to indicate that the TCI state with TCI state ID i is not indicated with a TCI status by Sm field. The Sm field to which the TCI State is mapped is determined by its ordinal position among all the TCI States with Ti field set to 1, i.e. the first TCI State with Ti field set to 1 shall be mapped to the S0, second TCI State with Ti field set to 1 shall be mapped to the Sm−1 and so on. The maximum number of TCI states be indicated with a TCI status by S field is m;
Sm: The second TCI status indicator. The Sm field is set to 1 to indicate that the TCI state mapped to this field should be switched to active status, the Sm field is set to 0 to indicate that the TCI state mapped to this field should be switched to semi-active status.
R: Reserved bit, e.g., set to 0.

In further embodiments, the WTRU may be indicated by the network node with a TCI set status exchange indicator. The received TCI set status exchange indicator may indicate to the WTRU to exchange the TCI set status of a first TCI set and a second TCI set. Wherein the TCI set status exchange indicator may be but not limited to be carried by a RRC message, a MAC CE or a DCI;

Specifically, the TCI set status exchange indicator may carry one or more of the following pieces of information: A first TCI set ID; A second TCI set ID.

Exchange may mean that the first TCI state takes the status of the second TCI state and the second TCI state takes the status of the first TCI state, e.g., TCI status swapping.

In one embodiment, the TCI status indicator, TCI set status indicator and/or the TCI set status exchange indicator may be implicitly indicated by a specific codepoint of a TCI field in DCI. Wherein the TCI field may be but not limited to be a field applied for the network node to indicate TCI state (as legacy). That is, a WTRU receives a DCI carrying the TCI field. The WTRU may determine how to interpret the TCI field. Specifically, the WTRU may determine that the TCI field is indicating a TCI state if the TCI field having a value which is not equal to the specific codepoint. In another example, the WTRU may determine that the TCI field is indicating the TCI status switching (TCI set status switching) and/or TCI set status exchanging if the TCI field having a value within or not within a specific range. The specific range may be pre-configured by the network node or pre-defined in the specification.

In one example, the WTRU may determine to switch TCI status in response to the TCI field carrying a value which is equal to the specific codepoint.

In a further embodiment, the WTRU may switch a specific TCI state to semi-active status in response to the WTRU receiving a DCI having a specific field that is set to a code point associated with the specific TCI state. Wherein the specific field is introduced for indicating which TCI state should be switched to semi-active status.

In further embodiments, the status switching indicator and/or the TCI set status exchange indicator may be explicitly indicated by a specific field in DCI. Wherein the specific field may be a newly defined field which may, but is not limited to, be a dedicated field with the purpose of the network node indicating TCI status, TCI set status and/or TCI set status exchange.

In one embodiment, the WTRU receives a DCI and the DCI having a first field and a second field (e.g., legacy TCI field). In case of the first field sets to a specific code point, the second field indicates to the WTRU that one of active TCI states (TCI sets) is applied (e.g., for PDSCH reception). In case the first field is set to a code point which is not the specific code point, the first field indicates the WTRU one of the semi-active TCI states (TCI sets) to be switched to active status, and the second field indicates the WTRU one of the active TCI states (TCI sets) to be switched to semi-active status.

In another embodiment, a WTRU is configured with multiple TCI states (TCI sets). The multiple TCI states (TCI sets) may be further grouped into one or more pairs via either RRC and/or MAC CE. Then, the network node may apply an individual indicator to indicate the WTRU to exchange the TCI status (TCI set status) between the pairs of TCI states (TCI sets). For example, the WTRU is configured with TCI set 1 and TCI set 2. The WTRU is also configured that the TCI set 1 and TCI set 2 are a pair. The TCI set 1 is in active status, and the TCI set 2 is in semi-active status. Then, by receiving the individual indicator from the network node, the WTRU may determine to exchange the TCI set status between the TCI set 1 and the TCI set 2. That is, WTRU switches the TCI set 1 to semi-active status, and switched the TCI set 2 to active status. Wherein the individual indicator may be carried by a specific field of a DCI.

In another embodiment, the WTRU may switch a specific TCI set to semi-active status in response to the WTRU receive a DCI having a TCI field is set to specific value. Wherein the specific TCI set may be a TCI set which pre-indicated by the network node via RRC signaling.

In a further embodiment, the WTRU may switch a specific TCI set to semi-active status in response to the WTRU receive a DCI having a specific filed is set to a code point associated with the specific TCI set. Wherein the specific field is introduced for indicating which TCI set should be switched to semi-active status.

It is noted that the SSI introduced in the present disclosure may not be limited to be applied for indicating TCI status (or TCI set status) switching. The TCI status indicator (or the TCI set status indicator) for a TCI state (or a TCI set) carried by the SSI may be interpreted as indicating WTRU to apply a specific RS monitoring behavior/pattern and/or a new RS monitoring behavior to meet a specific timeline (or requirement) defined and illustrated in the sections “Confirmation of the status indication”, “State-based TCI set and TCI state application delay determination” and so on. That is, the WTRU may be indicated, by the TCI status indicator (or the TCI set status indicator), to either apply a first RS monitoring behavior/pattern and/or a first RS monitoring behavior to meet a first timeline (or first requirement), or to apply a second RS monitoring behavior/pattern and/or a second RS monitoring behavior to meet a second timeline (or second requirement) for a TCI state (or TCI set).

Specifically, a TCI state in semi-active status mentioned in the present disclosure may be interpreted as the WTRU should, but is not limited to, monitor the TCI state corresponding source RS (as defined in section “Hierarchical Source RS tracking management”) to meet the D2 requirement while the TCI state is indicated to switch to active status.

It is noted that the mechanism introduced in this section does not preclude that the WTRU is pre-configured with an initial status for a TCI state and/or an initial status for a TCI set. The initial TCI status and/or the initial TCI set status may be further modified, changed and/or exchanged by one or more of the mechanism(s) introduced in the present section.

### Confirmation of the Status Indication

### [TCI State Applied After the Application Delay to Receive Downlink Channel, and WTRU Reports Confirmation.]

In response to receiving the TCI status indicator, the TCI set status indicator and/or the TCI set status exchange indicator, the WTRU may trigger the corresponding TCI status switching, TCI set status switching and/or TCI set status exchange respectively.

Consider the WTRU receiving a TCI status indicator indicating the WTRU to switch a TCI status of a TCI state from a 1st TCI status to a 2nd TCI status. In response to receiving the TCI status indicator, the WTRU may trigger the procedure for switching from the 1st TCI status to the 2nd TCI status for the TCI state. However, there may be processing delay needed by the WTRU to accomplish the corresponding switching. Also, it is important to let the network node know whether the corresponding TCI status indicator has been received by the WTRU correctly. Hence, the WTRU may need to send a confirmation message, e.g., an acknowledgement (ACK), in response to receiving the TCI status indicator. Specifically, the WTRU may transmit the confirmation message to the network node to indicate that the TCI status indicator is received.

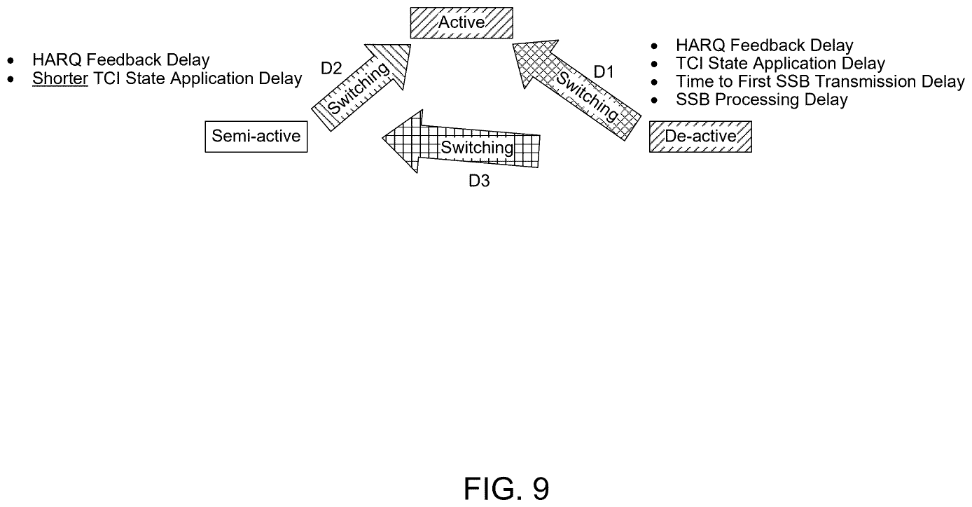

It is noted that the time needed for a WTRU to complete the switching process for a TCI state from a de-active status to active status (D1), from a semi-active status to active status (D2) and from a de-active status to semi-active status (D3) may be different, as shown in FIG. 9.

That is, for example, if the WTRU received a TCI status indicator indicating to switch a TCI state from semi-active status to active status, the WTRU needs to have the indicated TCI state ready to be indicated to be applied for corresponding PDSCH reception, PDCCH monitor, PUSCH transmission and/or PUCCH transmission within the D2 delay. Wherein the D2 may, but is not limited to, be starting from a time:
The (first or last symbol or slot the) WTRU receives a PDCCH indicating a downlink reception, e.g., a PDSCH, and the TCI status indicator is received via the downlink reception;
The (first or last symbol or slot the) WTRU receives a DCI indicating a downlink reception, e.g., a PDSCH, and the TCI status indicator is received via the downlink reception; At the end of WTRU receives a PDCCH indicating a downlink reception, and the TCI status indicator is received via the downlink reception. For example, the end of a last symbol, end of a sub-slot, end of a slot or an end of sub-frame of receiving the PDCCH;
The WTRU receives a PDSCH carrying the TCI status indicator; and/or
At the end of WTRU receives a PDSCH carrying the TCI status indicator. For example, the end of a last symbol, end of a sub-slot, end of a slot or a end of sub-frame of receiving the PDSCH.

### Hierarchical Source RS Tracking Management

Multi-Tiers RS Tracking

### [Source RSs Tracking for TCI States of a TCI Set be Categorized Into Different Tiers]

### [Tracking Different Type of Source RS of a TCI State Depending on the TCI State (Set) Status]

E.g., If a TCI state is in a first status, tracking the source RS (e.g., QCL type A & D) in order to meet the TCI state switch delay;

E.g., If a TCI state is in a second status, tracking the source RS (e.g., QCL type D) less frequently, in order to meet the TCI state D2 delay.

In order to meet a certain TCI state application delay, a WTRU may need to perform a source RS tracking procedure for a configured TCI state. That is, the WTRU may need to receive the source RS, and estimate the indicated type of QCL property based on the received source RS of the TCI state. However, the RS tracking procedure performed by the WTRU for a TCI state may be different according to the TCI status of the TCI state.

In one embodiment, the RS tracking procedure for a TCI state according to TCI status may, but is not limited to, comprise one or more of:
The WTRU monitors a first type of source RS when the TCI state is in a first TCI status, and WTRU monitors a second type of source RS when the TCI state is in a second TCI status;
The WTRU monitors both a first type of source RS and a second type of source RS when the TCI state is in a first TCI status, and WTRU monitors the second type of source RS when the TCI state is in a second TCI status;
The WTRU monitors a representative RS when the TCI state is in a first TCI status, and the WTRU monitors the source RS configured for QCL property estimation while the TCI state is in a second TCI status. Wherein the representative RS may, but is not limited to, be configured by the network node via any of the mechanisms introduced earlier in the present disclosure;
Wherein the first type of source RS is configured for first type of QCL property estimation and the second type of source RS is configured for the second type of QCL property estimation.

Wherein the WTRU monitors a source RS may be interpreted as the WTRU tracks the source RS.

In one embodiment, the RS tracking procedure for a TCI set in semi-active status may, but is not limited to, comprise one or more of:
A) WTRU monitors source RS of a first type of TCI state (e.g., FF TCI state) of the TCI set while the TCI set is in a first TCI set status, and WTRU monitors source RS of a second type of TCI state (e.g., NF TCI state) of the TCI set while the TCI set is in a second TCI set status;
B) WTRU monitors a source RS of a representative TCI state in the TCI set while the TCI set is a first TCI set status, and WTRU monitors source RS of a specific type of TCI state (e.g., NF/FF TCI state) of the TCI set while the TCI set in a second TCI set status. Wherein the representative TCI state may be but not limited to be configured by the network node via any of mechanism introduced earlier in the present disclosure;
C) WTRU monitors a source RS of a representative TCI state in the TCI set while the TCI set is a first TCI set status, and WTRU monitors source RS of all TCI state of the TCI set while the TCI set in a second TCI set status. Wherein the representative TCI state may, but is not limited to, be configured by the network node via any of the mechanisms introduced earlier in the present disclosure.

It is noted that “a WTRU monitors a source RS” mentioned in this disclosure may be interpreted as “the WTRU monitors the source RS to meet a specific pre-defined (channel) reception requirement (e.g., error rate)”; “the WTRU performs different monitoring behavior on source RS of a TCI state according to TCI status of the TCI state” may be interpreted as “the WTRU performs the source RS monitoring differently in order to meet different (channel) reception requirements.

### [Tracking Source RS of a TCI State to Meet TCI State Switching Delay]

Besides the active (or activated) TCI status and the de-active (or de-activated) TCI status, the present document introduced a new status named a “semi-active” (or “semi-activated”) TCI status. That is, a TCI state may be in either one of an active, de-active (inactive) or semi-active status. As introduced earlier, a TCI state configured by RRC may be indicated with an initial TCI status, e.g., de-active. The initial TCI status may be indicated to be switched to another TCI status based on L2 or L1 signaling. A WTRU may perform different source RS monitoring behavior for the TCI state according to the TCI status of the TCI state.

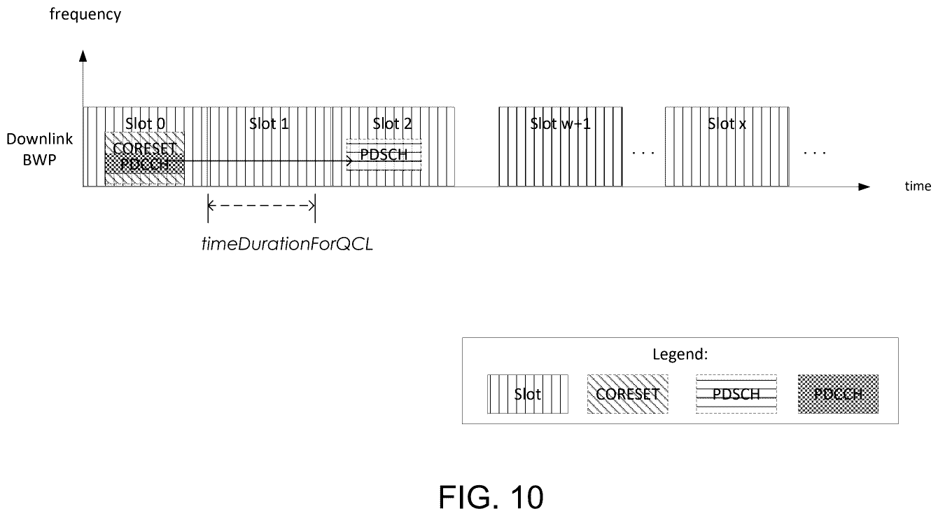

Also, as addressed earlier, the WTRU needs to meet an application delay requirement for a TCI state that is in active status. The application delay may be defined as the time between the WTRU is indicated to apply the TCI state for a downlink channel reception, and the WTRU is ready to apply the TCI state for the downlink channel reception. As shown in FIG. 10, the WTRU receives a PDCCH in a CORESET in slot 0 indicating a PDSCH reception in slot 2. The PDCCH further indicates that the PDSCH reception should apply a TCI state (which is in active status). The time interval between the PDCCH and the PDSCH should be larger than the application delay (i.e., timeDurationForQCL). Wherein the application delay may be one of WTRU's capabilities reported to the network node. In one embodiment, based on that the WTRU performs source RS monitoring corresponding to the TCI state for QCL property estimation, the WTRU may be ready to apply the TCI state for the PDSCH reception. However, the source RS monitoring for meeting the application delay requirement may be costly (e.g., increasing WTRU's power consumption). That is, to ensure a TCI state, that is in active status, can be applied in specific short delay, WTRU needs to spend its effort on tracking source RS(s) of the active TCI state(s).

On the other hand, the WTRU may not necessarily need to spend its effort on monitoring source RS of a TCI which is in de-active status. But the price may be that the WTRU may need more time to make the TCI state ready to be applied for channel reception, when needed. That is, once the TCI state needs to be applied for channel reception, the WTRU needs to switch the TCI state from de-active status to active status. The switching delay from de-active status to active status (i.e., D1) may be significantly larger than the TCI state application delay just mentioned above.

The semi-active status that has been introduced may reduce WTRU's effort on source RS tracking and may reduce the TCI status switching delay. That is, by indicating that the TCI state is in semi-active status, the WTRU only needs to spend a light effort on source RS tracking for the TCI state in semi-active status. In return, the TCI state may be ready to be applied for channel reception in a shorter delay. That is, the switching delay from semi-active to active status (D2) may be shorter than D1.

That is, the WTRU may at least monitor source RS of the TCI state in semi-active status in order to meet the TCI status switching requirement (i.e., D2). It is noted that D2 may be a WTRU capability reported by the WTRU to the network node.

It is noted that the embodiments for D2 and D1 may be applied for TCI set status switching delay for a TCI set as well. That is, D2 may be interpreted as the switching delay for the TCI set status switching from semi-active status to active status. Similar, D1 may be interpreted as the switching delay for the TCI set status switching from de-active status to active status It is noted that there may be an alternative way to implement the semi-active status concept (mechanism). For example, the WTRU may be pre-configured or pre-defined with a first TCI state application delay requirement and a second TCI state application delay requirement. The WTRU may be further indicated by the network node via either L2 or L1 signaling to take action and/or perform a proper procedure (e.g., monitoring corresponding source RS with particular frequency) to meet one of the first TCI state application delay requirement or the second TCI state application delay requirement. In response to one of the first TCI state application delay requirement or the second TCI state application delay requirement being indicated by the network node, the WTRU may need to perform corresponding source RS monitoring behavior to meet corresponding delay requirement. For example, the WTRU is configured with a first monitoring configuration and a second monitoring configuration. The first monitoring configuration may indicate WTRU a first RS monitoring frequency and/or a first particular QCL type indicator. The second monitoring configuration may indicate WTRU a second RS monitoring frequency and/or a second particular QCL type indicator. In response to the first TCI state application delay requirement being indicated by the network node, the WTRU monitoring corresponding source RS based on the first monitoring configuration. For example, monitoring corresponding source with the first frequency and/or monitoring a source RS determined based on the first particular QCL type indicator. That is, the first particular QCL type indicator indicates either QCL type A, B, C, D and/or other(s). The WTRU monitors a source RS associated with the indicated QCL type. In response to the second TCI state application delay requirement is indicated by the network node, the WTRU monitoring corresponding source RS based on the second monitoring configuration. For example, monitoring corresponding source with the second frequency and/or monitoring a source RS determined based on the second particular QCL type indicator.

It is also note that the one of the first TCI state application delay requirement and the second TCI state application delay requirement may be either indicated by one or more TCI status indicator (e.g., SSI) introduced earlier in the present disclosure or some other indicators.

### Applying TCI State and TCI Set

Per the embodiments introduced in the present document, a WTRU may be configured with one or more TCI sets. Within the one or more TCI set, at least a TCI set is indicated as active status. The WTRU may determine a TCI set application delay based on a reported specific WTRU capability. Wherein the specific WTRU capability may be defined as the minimal time the WTRU needs to let a TCI state in the TCI set be ready to be applied for channel reception or transmission.

In one embodiment, a WTRU is configured with a first TCI set and a second TCI set. The first TCI set consists of at least a FF TCI state and at least a NF TCI state. The second TCI set consists of at least a FF TCI state and at least a NF TCI state. The first TCI set is now in active status while the second TCI set is in semi-active status. The WTRU receives a SSI indicating to switch the first TCI set to semi-active status and indicating to switch the second TCI set to active status. After the WTRU receives the TCI set status switching indicator and before the WTRU finished/completed the corresponding TCI set status switching process, the WTRU applies one of the FF TCI state of the first TCI set for PDCCH monitoring.

### Summary—FF Beam-Based TCI Set Selection

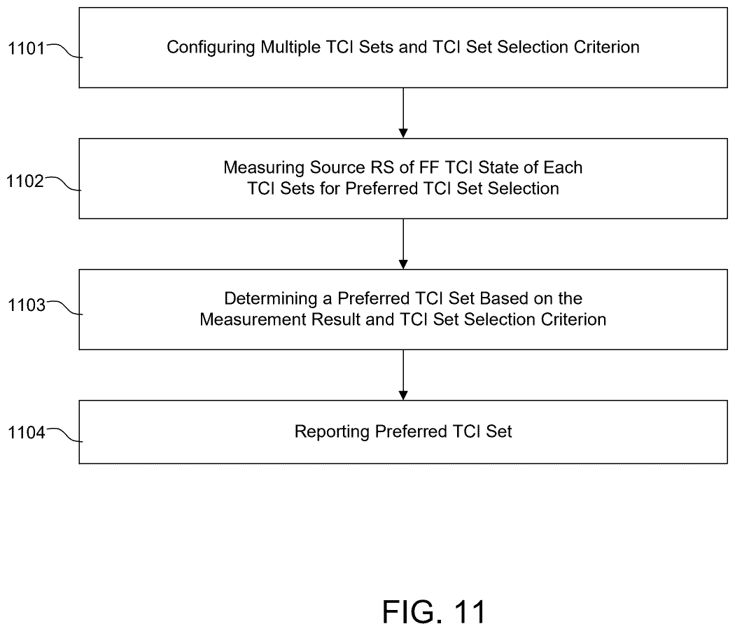

See FIG. 11, a WTRU may be configured with multiple TCI sets by RRC. Each TCI set consists of TCI states of NF beams (NF TCI state) and a TCI state of FF beam (FF TCI state). The WTRU determines and reports a preferred TCI set based on measurement on a source RS of a FF TCI state. The WTRU is indicated with an active TCI set and a semi-active TCI set via a MAC CE. The active/semi-active status can be switched via a DCI. The switching delay from semi-active to active is shorter than from de-active to active.

In 1101, a WTRU receives a RRC message from a network node, wherein the RRC message may consist of:
A) A TCI set configuration indicating multiple TCI sets each consists of multiple TCI states associated with NF beam (NF TCI states) and a TCI state associated with FF beam (FF TCI state);
B) A TCI set selection configuration indicating a TCI set selection criteria, E.g., RSRP threshold; E.g., RSRP over a period of time.

In 1102 and 1103, the WTRU measures and determines at least a preferred TCI set based on measurement of source RS of FF TCI state of each TCI set and the TCI set selection criteria; E.g., Selects a TCI set which consist of a FF TCI state which source RS having RSRP higher than specified in the TCI set selection criteria;

In 1104, the WTRU reports the preferred TCI set;

In a further step (further steps are not shown in the figure) the WTRU receives, from the network node, a MAC CE indicating a first TCI set in active status and a second TCI set in semi-active status;

In a further step, the WTRU receives a first DCI scheduling a first PDSCH reception, wherein the first DCI including a TCI indicator indicating a first value;

In a further step, the WTRU determines a TCI state to be applied for the first PDSCH reception based on the first value and the first TCI set;

In a further step, the WTRU receives, from the network node, a second DCI indicating to switch the first TCI set into semi-active status and indicating to switch the second TCI set into active status; E.g., a TCI field of the second DCI be set to a particular value indicating the status of the first and the second two TCI set should be exchanged;

In a further step, the WTRU receives a third DCI scheduling a second PDSCH reception, wherein the third DCI including a TCI indicator indicating a second value;

In a further step, the WTRU determines a TCI state to be applied for the second PDSCH reception based on the second value and the second TCI set.

### Summary—State-Based TCI Set and TCI State Application Delay Determination

A WTRU may report its TCI set corresponding capability to the network node. When the WTRU receives a DCI indicating switching a TCI set to active status from semi-active status, the WTRU determines an TCI application delay based on its reported capability and TCI status:
A WTRU may report, to a network node, a capability of a minimum delay for switching a TCI state from de-active status to active status, i.e., a first delay (D1);
The WTRU may report, to the network node, a semi-active TCI status specific capability comprising any of:
a) a minimum delay for switching a TCI state from semi-active status to active status, i.e., a second delay (D2);
b) a maximum number of semi-active TCI states may be configured;
c) a maximum number of TCI states is supported to be configured (MAX_{TCI});
d) MAX_{TCI} as function of number of active TCI states and number of semi-active TCI states, e.g., number of active TCI states plus number of semi-active TCI states <=MAX_{TCI}, or e.g., Ratio of between the number of active TCI states and number of semi-active TCI states;
e) a maximum number of TCI sets that are supported to be configured;
The WTRU may be configured, by the network node via a RRC message, with multiple sets of TCI states in de-active status; e.g., a TCI set is associated with a group of NF beams in same distance;

The WTRU may receive, from the network node, a MAC CE indicating a first set of TCI states in active status and a second set of TCI states in semi-active status; The WTRU may track, for the first set of TCI states, source RS of NF TCI states; The WTRU may track, for the second set of TCI states, source RS of FF TCI states to meet the D2 requirement;

The WTRU may activate the first set of TCI states and determine a first application delay for the first set of TCI based on D1;

The WTRU may receive a first DCI indicating to switch the first set of TCI states into semi-active status, and to switch the second set of TCI states into active status; e.g., the switching is determined based on a first codepoint in a TCI field of the first DCI;

The WTRU may determine a second application delay for the second set of TCI state based on at least D2;

The WTRU may receive a second DCI after the second application delay, wherein the second DCI indicates a second codepoint of the TCI field and the second DCI scheduling a PDSCH reception;

The WTRU may apply a TCI state determined by the second codepoint for the PDSCH reception.

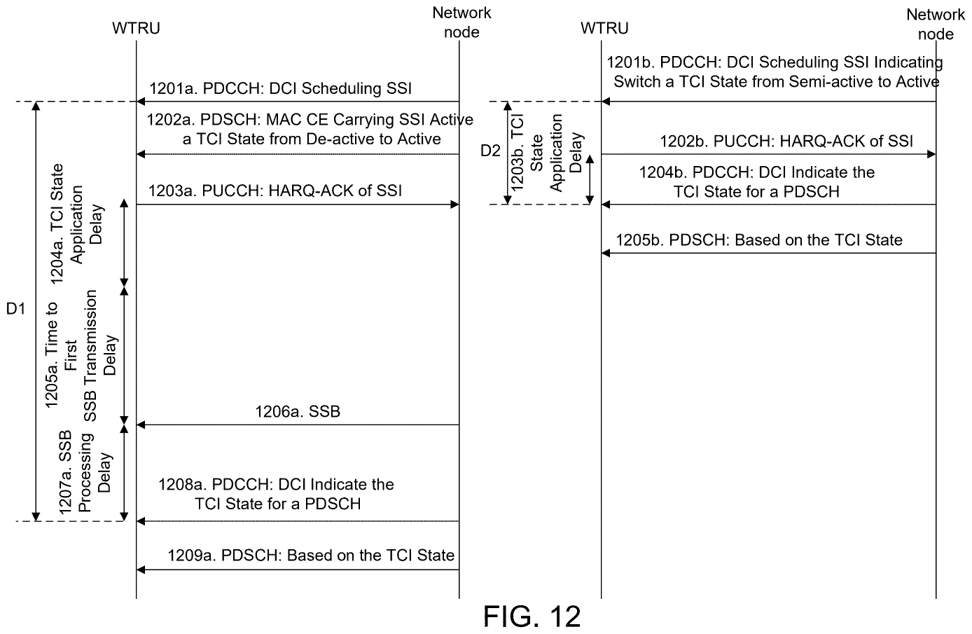

D1 and D2 are illustrated in FIG. 12.

In the left part of FIG. 12 (corresponding to the illustration of D1), in case a network node needs to schedule a PDSCH reception based on a TCI state with de-active status, the WTRU may execute the following steps to switch the TCI state to active status:
In 1201a, the WTRU receives a first DCI on a first PDCCH, and the first DCI scheduling a first PDSCH reception.

In 1202a, the WTRU receives the first PDSCH carrying a status switching indicator (SSI) in a MAC CE, indicating to switch a TCI status of a TCI state from de-active to active.

In 1203a, the WTRU transmits a HARQ feedback to the network node for confirming the reception of the first PDSCH.

In 1204a, the WTRU needs some application delay for applying the TCI state.

In 1205a, the WTRU needs to receive the TCI state's corresponding SSB transmission (wait until 1st SSB transmission occasion).

In 1206a, the WTRU receives the TCI state corresponding SSB.

In 1207a, the WTRU processes the received SSB. The WTRU is then ready to receive a DCI scheduling a second PDSCH which needs to be received based on the TCI state.

In 1208a, WTRU receives a second PDCCH carrying a second DCI scheduling a second PDSCH which need to be received based on the TCI state.

In 1209a, the WTRU receives the second PDSCH based on the TCI state.

Illustrated in the right part of FIG. 12 (corresponding to an illustration of D2), when compared to the mechanism introduced in the present document for semi-active status, the overall delay for a WTRU to be ready to apply a TCI state (i.e., D2) is shorter than D1. That is, in case a network node needs to schedule a PDSCH reception based on a TCI state with semi-active status, the WTRU may execute following steps to switch the TCI state to active status:
In 1201b, the WTRU receives a first DCI on a first PDCCH, and the first DCI indicating to switch a TCI status of a TCI state from semi-active to active.

In 1202b, the WTRU transmits a HARQ feedback to the network node for confirming the reception of the first DCI.

In 1203b, the WTRU needs some application delay for applying the TCI state, however the TCI state application delay may be shorter than the TCI state application delay for left part of FIG. 12. That is, based on the RS tracking effort mentioned in earlier sections in the present document, WTRU may keep track at least QCL type D source RS for TCI state in semi-active status, hence, the WTRU may be already familiar with the TCI state. Hence, a shorter TCI state application delay may be expected. After the TCI state application delay, the WTRU is ready to receive DCI scheduling a PDSCH which needs to be received based on the TCI state.

In 1204b, the WTRU receives a second PDCCH carrying a second DCI scheduling a PDSCH which need to be received based on the TCI state.

In 1205b, the WTRU receives the PDSCH based on the TCI state.

Based on the mechanism introduced in the present disclosure, the WTRU may have more TCI states that can be applied in a shorter delay. That is, by the WTRU spending less effort on tracking source RS of TCI state with semi-active status, the TCI states with semi-active status can be switched to active status in a shorter delay than is possible with legacy procedures.

### Summary—Delay Constrained-Based TCI Set and TCI State Application Delay Determination

A WTRU may report its TCI set application delay corresponding capability to a network node. The WTRU receives a DCI indicating delay requirement for a TCI set, the WTRU determines an TCI application delay based on its reported capability and indicated delay requirement:
A WTRU reports, to a network node, a capability of a first minimum delay for switching a TCI state to active status, i.e., a first delay (D1);
The WTRU reports, to the network node, a capability of a second minimum delay for switching a TCI state to active status, i.e., a second delay (D2);
The WTRU is configured, by the network node via a RRC message, with multiple sets of TCI states in de-active status;
The WTRU receives, from the network node, a MAC CE indicating a first delay requirement indicator for a first set of TCI states and indicating a second delay requirement indicator for a second set of TCI states; e.g., wherein the first delay requirement indicator indicates D1 and the second delay requirement indicator indicates D2;
The WTRU tracking, for the first set of TCI states, source RS of NF TCI states;
The WTRU tracking, for the second set of TCI states, source RS of FF TCI states to meet the D2 requirement;
The WTRU activating the first set of TCI states and determining a first application delay for the first set of TCI based on the D1;
The WTRU receiving a first DCI indicating to indicating a third delay requirement for a first set of TCI states and indicating a fourth delay requirement for a second set of TCI states;
The WTRU determining a second application delay for the second set of TCI state based on at least D2;
The WTRU receiving a second DCI after the second application delay, wherein the second DCI indicating a second codepoint of the TCI field and the second DCI scheduling a PDSCH reception;
The WTRU applies a TCI state determined by the second codepoint for the PDSCH reception.

### Summary—QCL Type-D RS Based TCI Set Selection

A WTRU may be configured with multiple TCI sets via RRC. Each TCI set consists of NF TCI states and FF TCI states. The WTRU determines and reports a preferred TCI set based on measurement on QCL type-D source RS of FF TCI states:
The WTRU receiving a RRC message from a network node, wherein the RRC message may comprise A) a TCI set configuration, indicating multiple TCI sets each consists of multiple NF TCI states and multiple FF TCI states. Each FF TCI states consist of a QCL type-D source RS indicator and a QCL type-A/B/C source RS indicator; B) A TCI set selection configuration, indicating a TCI set selection criteria; E.g., RSRP threshold.

The WTRU measuring and determining at least a preferred TCI set based on QCL type-D source RS indicator of FF TCI state of each TCI set and the TCI set selection criteria; e.g., measurement on source RS of FF TCI states indicating by the QCL-type-D source RS indicator(s) of each TCI set; e.g., Selects a TCI set which consist of FF TCI states which average RSRP of each QCL type-D source RS having RSRP higher than the TCI set selection criteria;

The WTRU reporting the preferred TCI set to the network node;

The WTRU receiving, from the network node, a MAC CE indicating a first TCI set in active status and a second TCI set in semi-active status;

The WTRU receiving a first DCI scheduling a first PDSCH reception, wherein the first DCI comprises a TCI indicator indicating a first value.

The WTRU determining a TCI state to be applied for the first PDSCH reception based on the first value and the first TCI set;

The WTRU receiving, from the network node, a second DCI indicating to switch the first TCI set to semi-active status and indicating to switch the second TCI set to active status;

The WTRU receiving a third DCI scheduling a second PDSCH reception, wherein the third DCI including a TCI indicator indicating a second value;

The WTRU determining a TCI state to be applied for the second PDSCH reception based on the second value and the second TCI set.

### Summary—TCI State Determination Before TCI Status Switching Delay (i.e., D2)

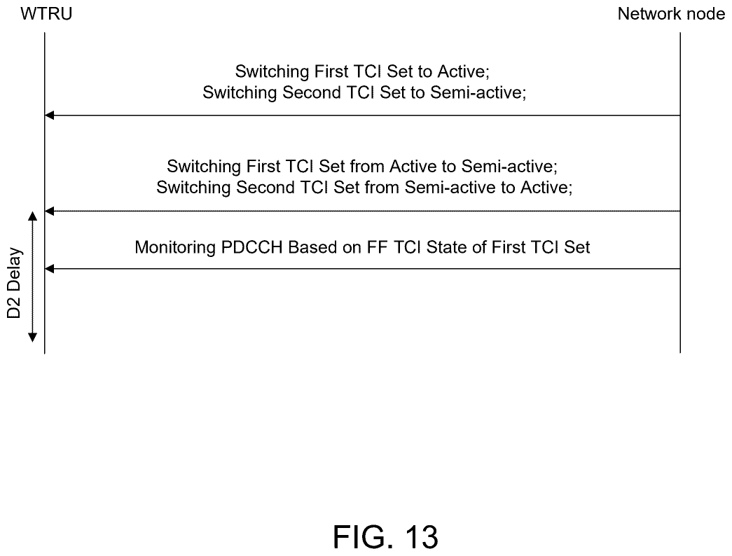

See FIG. 13. A WTRU receives a DCI indicating switching a TCI set to active status from semi-active status, the WTRU determines to apply FF TCI state for PDCCH monitoring before D2:
The WTRU reporting, to a network node, a capability of a minimum delay for switching a TCI state from de-active status to active status, i.e., a first delay (D1);
The WTRU reporting, to the network node, a semi-active TCI status specific capability comprising: a minimum delay for switching a TCI state from semi-active status to active status, i.e., a second delay (D2);
The WTRU is configured, by the network node via a RRC message, with multiple sets of TCI states in de-active status; e.g., a TCI set is associated with a group of NF beams in same distance;
The WTRU receiving, from the network node, a MAC CE indicating a first set of TCI states in active status and a second set of TCI states in semi-active status; the WTRU tracking, for the first set of TCI states, source RS of TCI states associated with NF beams; the WTRU tracking, for the second set of TCI states, source RS of TCI states associated with FF beams;
The WTRU activating the first set of TCI states and determining a first application delay for the first set of TCI based on D1;
The WTRU receiving a first DCI indicating to switching the first set of TCI states into semi-active status, and to switching the second set of TCI states into active status;
The WTRU determining a second application delay for the second set of TCI state based on at least D2;
The WTRU applying the FF TCI state of the second set of TCI states for PDCCH monitoring before the second application delay (D2).

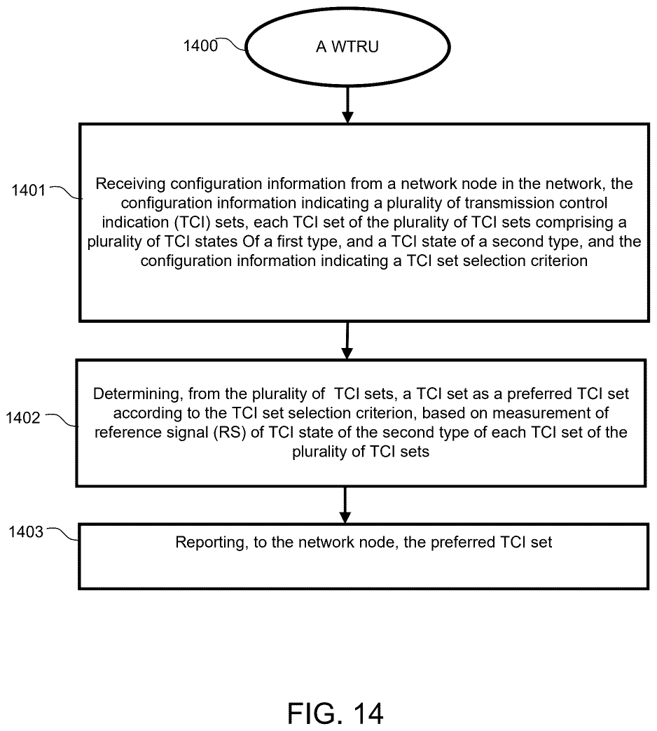

FIG. 14 is a flow chart of an embodiment of a method 1400 for TCI management in NF.

The method may be implemented by a wireless transmit-receive unit in a network. The method may comprise:
In 1401, receiving configuration information from a network node in the network, the configuration information indicating a plurality of transmission control indication (TCI) sets, each TCI set of the plurality of TCI sets comprising a plurality of TCI states of a first type, and a TCI state of a second type, and the configuration information indicating a TCI set selection criterion;
In 1402, determining, from the plurality of TCI sets, a TCI set as a preferred TCI set according to the TCI set selection criterion, based on measurement of reference signal (RS) of TCI state of the second type of each TCI set of the plurality of TCI sets; and
In 1403, reporting, to the network node, the preferred TCI set.

According to an embodiment, the method comprises receiving, from the network node, control information, the control information indicating to set a first TCI set of the plurality of TCI sets into active status, and the control information indicating to set a second TCI set of the plurality of TCI sets into semi-active status, wherein an active status of a TCI set corresponds to a first RS monitoring pattern for meeting a first delay for applying the TCI set for performing downlink (DL) channel reception and/or uplink (UL) channel transmission, and wherein a semi-active status of a TCI set corresponds to a second RS monitoring pattern for meeting a second delay for applying the TCI set for performing DL channel reception and/or uplink UL channel transmission, the second delay being longer than the first delay; and receiving, from the network node, downlink control information (DCI) indicating to switch the first TCI set to semi-active status and to switch the second TCI set to active status, and switching the second TCI set from semi-active status to active status and switching the first TCI set from active status to semi-active status.

According to an embodiment, the first TCI set corresponds to the preferred TCI set.

According to an embodiment, when determining a preferred TCI set according to the TCI set selection criterion, a TCI set is a preferred TCI set when one or more of: a measurement result of a TCI state of the second type within the TCI set meets a first TCI set selection threshold comprised in the TCI set selection criterion; and/or a measurement results of one or more TCI states of the first type within the TCI set meets a second TCI set selection threshold comprised in the TCI set selection criterion.

According to an embodiment, when determining a preferred TCI set according to the TCI set selection criterion, a TCI set is a preferred TCI set when one or more of: a measurement result of a TCI state of the second type within the TCI set meets a first TCI set selection threshold comprised in the TCI set selection criterion; and/or measurement results of more than m TCI states of the first type within the TCI set meets a second TCI set selection threshold comprised in the TCI set selection criterion.

According to an embodiment, applying a TCI set corresponds to using quasi-colocation (QCL) properties according to active status or semi-active state status, for performing the DL channel reception and/or the UL channel transmission.

According to an embodiment, the TCI set selection criterion is based on reference signal received power of the measured RS.

According to an embodiment, the first type is associated with a near field beam, and the second type is associated with a far field beam.

There is also disclosed and described a wireless transmit-receive unit device in a network. The WTRU comprises at least one processor configured to:
receive configuration information from a network node in the network, the configuration information indicating a plurality of transmission control indication (TCI) sets, each TCI set of the plurality of TCI sets comprising a plurality of TCI states of a first type, and a TCI state of a second type, and the configuration information indicating a T CI set selection criterion;
determine, from the plurality of TCI sets, a TCI set as a preferred TCI set according to the TCI set selection criterion, based on measurement of reference signal (RS) of TCI state of the second type of each TCI set of the plurality of TCI sets; and
report, to the network node, the preferred TCI set.

According to an embodiment, the at least one processor is configured to:
receive, from the network node, control information, the control information indicating to set a first TCI set of the plurality of TCI sets into active status, and the control information indicating to set a second TCI set of the plurality of TCI sets into semi-active status, wherein an active status of a TCI set corresponds to a first RS monitoring pattern for meeting a first delay for applying the TCI set for performing downlink (DL) channel reception and/or uplink (UL) channel transmission, and wherein a semi-active status of a TCI set corresponds to a second RS monitoring pattern for meeting a second delay for applying the TCI set for performing DL channel reception and/or uplink UL channel transmission, the second delay being longer than the first delay; and to receive, from the network node, downlink control information (DCI) indicating to switch the first TCI set to semi-active status and to switch the second TCI set to active status, and switch the second TCI set from semi-active status to active status and switch the first TCI set from active status to semi-active status.

According to an embodiment, the first TCI set corresponds to the preferred TCI set.

According to an embodiment, to determine the preferred TCI set according to the TCI set selection criterion, a TCI set is a preferred TCI set when one or more of: a measurement result of a TCI state of the second type within the TCI set meets a first TCI set selection threshold comprised in the TCI set selection criterion; and/or a measurement results of one or more TCI states of the first type within the TCI set meets a second TCI set selection threshold comprised in the TCI set selection criterion.

According to an embodiment, to determine the preferred TCI set according to the TCI set selection criterion, a TCI set is a preferred TCI set when one or more of: a measurement result of a TCI state of the second type within the TCI set meets a first TCI set selection threshold comprised in the TCI set selection criterion; and/or measurement results of more than m TCI states of the first type within the TCI set meets a second TCI set selection threshold comprised in the TCI set selection criterion.

According to an embodiment, applying a TCI set corresponds to using quasi-colocation (QCL) properties according to active status or semi-active state status, for performing the DL channel reception and/or the UL channel transmission.

According to an embodiment, the TCI set selection criterion is based on reference signal received power of the measured RS.

According to an embodiment, the first type is associated with a near field beam, and the second type is associated with a far field beam.

### Conclusion

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

1. A method, implemented by a wireless transmit-receive unit in a network, the method comprising:
receiving configuration information from a network node in the network, the configuration information indicating a plurality of transmission control indication (TCI) sets, each TCI set of the plurality of TCI sets comprising a plurality of TCI states of a first type, and a TCI state of a second type, and the configuration information indicating a TCI set selection criterion;
determining, from the plurality of TCI sets, a TCI set as a preferred TCI set according to the TCI set selection criterion, based on measurement of reference signal (RS) of the TCI state of the second type of each TCI set of the plurality of TCI sets; and
reporting, to the network node, the preferred TCI set.

2. The method of claim 1, comprising:
receiving, from the network node, control information, the control information indicating to set a first TCI set of the plurality of TCI sets into active status, and the control information indicating to set a second TCI set of the plurality of TCI sets into semi-active status, wherein an active status of a TCI set corresponds to a first RS monitoring pattern for meeting a first delay for applying the TCI set for performing downlink (DL) channel reception and/or uplink (UL) channel transmission, and wherein a semi-active status of a TCI set corresponds to a second RS monitoring pattern for meeting a second delay for applying the TCI set for performing DL channel reception and/or uplink UL channel transmission, the second delay being longer than the first delay; and
receiving, from the network node, downlink control information (DCI) indicating to switch the first TCI set to semi-active status and to switch the second TCI set to active status, and switching the second TCI set from semi-active status to active status and switching the first TCI set from active status to semi-active status.

3. The method of claim 2, wherein the first TCI set corresponds to the preferred TCI set.

4. The method of claim 1, wherein, when determining of a preferred TCI set according to the TCI set selection criterion, a TCI set is a preferred TCI set when one or more of: a measurement result of a TCI state of the second type within the TCI set meets a first TCI set selection threshold comprised in the TCI set selection criterion; and/or a measurement results of one or more TCI states of the first type within the TCI set meets a second TCI set selection threshold comprised in the TCI set selection criterion.

5. The method of claim 1, wherein, when determining of a preferred TCI set according to the TCI set selection criterion, a TCI set is a preferred TCI set when one or more of: a measurement result of a TCI state of the second type within the TCI set meets a first TCI set selection threshold comprised in the TCI set selection criterion; and/or measurement results of more than m TCI states of the first type within the TCI set meets a second TCI set selection threshold comprised in the TCI set selection criterion.

6. The method of claim 2, wherein applying a TCI set corresponds to using quasi-colocation (QCL) properties according to active status or semi-active state status, for performing the DL channel reception and/or the UL channel transmission.

7. The method of claim 1, wherein the TCI set selection criterion is based on reference signal received power of the measured RS

8. The method of claim 1, wherein the first type is associated with a near field beam, and the second type is associated with a far field beam.

9. A wireless transmit-receive unit (WTRU) in a network, the WTRU comprising at least one processor configured to:
receive configuration information from a network node in the network, the configuration information indicating a plurality of transmission control indication (TCI) sets, each TCI set of the plurality of TCI sets comprising a plurality of TCI states of a first type, and a TCI state of a second type, and the configuration information indicating a TCI set selection criterion;
determine, from the plurality of TCI sets, a TCI set as a preferred TCI set according to the TCI set selection criterion, based on measurement of reference signal (RS) of the TCI state of the second type of each TCI set of the plurality of TCI sets; and
report, to the network node, the preferred TCI set.

10. The WTRU of claim 9, wherein the at least one processor is configured to:
receive, from the network node, control information, the control information indicating to set a first TCI set of the plurality of TCI sets into active status, and the control information indicating to set a second TCI set of the plurality of TCI sets into semi-active status, wherein an active status of a TCI set corresponds to a first RS monitoring pattern for meeting a first delay for applying the TCI set for performing downlink (DL) channel reception and/or uplink (UL) channel transmission, and wherein a semi-active status of a TCI set corresponds to a second RS monitoring pattern for meeting a second delay for applying the TCI set for performing DL channel reception and/or uplink UL channel transmission, the second delay being longer than the first delay; and
receive, from the network node, downlink control information (DCI) indicating to switch the first TCI set to semi-active status and to switch the second TCI set to active status, and switch the second TCI set from semi-active status to active status and switch the first TCI set from active status to semi-active status.

11. The WTRU of claim 10, wherein the first TCI set corresponds to the preferred TCI set.

12. The WTRU of claim 9, wherein to determine the preferred TCI set according to the TCI set selection criterion, a TCI set is a preferred TCI set when one or more of: a measurement result of a TCI state of the second type within the TCI set meets a first TCI set selection threshold comprised in the TCI set selection criterion; and/or a measurement results of one or more TCI states of the first type within the TCI set meets a second TCI set selection threshold comprised in the TCI set selection criterion.

13. The WTRU of claim 9, wherein, to determine the preferred TCI set according to the TCI set selection criterion, a TCI set is a preferred TCI set when one or more of: a measurement result of a TCI state of the second type within the TCI set meets a first TCI set selection threshold comprised in the TCI set selection criterion; and/or measurement results of more than m TCI states of the first type within the TCI set meets a second TCI set selection threshold comprised in the TCI set selection criterion.

14. The WTRU of claim 10, wherein applying a TCI set corresponds to using quasi-colocation (QCL) properties according to active status or semi-active state status, for performing the DL channel reception and/or the UL channel transmission.

15. The WTRU of claim 9, wherein the TCI set selection criterion is based on reference signal received power of the measured RS.

16. The WTRU of claim 9, wherein the first type is associated with a near field beam, and the second type is associated with a far field beam.
